(19) United States
(12) Patent Application Publication
(10) Pub. No.: US 2019/0305571 A1
(43) Pub. Date: Oct. 3, 2019

(54) CONVENIENCE CHARGER AND COMBINATION

(71) Applicant: HCL DESIGNS, LLC, NAPLES, FL (US)

(72) Inventors: Robert E. TUFFY, Hanover, MA (US); Michael Bergman, Somerville, MA (US)

(73) Assignee: HCL DESIGNS, LLC, Naples, FL (US)

(21) Appl. No.: 16/405,893

(22) Filed: May 7, 2019

Related U.S. Application Data
(63) Continuation of application No. PCT/US2017/060470, filed on Nov. 7, 2017.
Application No. PCT/US2017/060470 is a continuation-in-part of application No. 15/859,485, filed on Dec. 30, 2017.
Application No. 15/859,485 is a continuation-in-part of application No. PCT/US2016/040883, filed on Jul. 1, 2016.
Application No. 15/859,485 is a continuation-in-part of application No. 29/603,444, filed on May 9, 2017, now Pat. No. D835034.
Application No. 29/603,444 is a continuation-in-part of application No. 29/604,372, filed on May 17, 2017, now Pat. No. D824851.
Application No. 29/604,372 is a continuation-in-part of application No. 29/604,439, filed on May 17, 2017.
Application No. 29/604,439 is a continuation of application No. PCT/US2017/060470, filed on Nov. 7, 2017.
Application No. PCT/US2017/060470 is a continuation-in-part of application No. PCT/US2016/040883, filed on Jul. 1, 2016.
(60) Provisional application No. 62/418,556, filed on Nov. 7, 2016.
(60) Provisional application No. 62/461,175, filed on Feb. 20, 2017.
(60) Provisional application No. 62/483,458, filed on Apr. 9, 2017.
(60) Provisional application No. 62/525,255, filed on Jun. 27, 2017.
(60) Provisional application No. 62/187,389, filed on Jul. 1, 2015.
(60) Provisional application No. 62/262,722, filed on Dec. 3, 2015.
(60) Provisional application No. 62/277,892, filed on Jan. 12, 2016.
(60) Provisional application No. 62/343,084, filed on May 30, 2016.

(51) Int. Cl. H02J 7/00; H02J 7/02; A47F 9/00; A47G 29/08

(52) U.S. Cl. CPC H02J 7/0045; H02J 7/025; A47B 2220/0091; A47G 29/083; A47F 9/00

(57) ABSTRACT

A charging system for a personal electronic device provides individual localized outlets along with convenience features for a domestic user or a patron of a hospitality facility.

### CROSS-REFERENCE TO RELATED APPLICATIONS

The present application claims the benefit of U.S. provisional patent application No. 62/418,556 filed on Nov. 7, 2016, and of U.S. provisional patent application No. 62/461,175 filed on Feb. 20, 2017, and of U.S. provisional patent application No. 62/483,458 filed on Apr. 9, 2017, and of U.S. provisional patent application No. 62/525,255 filed on Jun. 27, 2017, and is a continuation in part of International application number PCT/US2016/040883 filed on Jul. 1, 2016, the disclosures of all of which are herewith incorporated by reference in their entireties.

### FIELD OF THE INVENTION

The present invention relates to electronic systems, and more particularly to electronic device charging systems.

### SUMMARY

Access to information, and personal availability for communication, are defining characteristics of our era. This access and availability are ubiquitous and continuous. Almost everyone is online all the time.

Much of the bandwidth involved in these communications is devoted to trivialities. Nevertheless, within the mass of inconsequential information there are individual items that, alone or in combination, have great consequence for our social and commercial relationships. We all understand that missing one item of information or failing to respond to a crucial inquiry from a client or social partner can have a disproportionate impact on our lives. Because of this, many of us have come to rely deeply on our personal electronic devices in ways that we perceive both consciously and intuitively. As a result, there is an urgent motivation to keep these devices functional.

The inventors of the present invention have, through personal experience, analysis, and the careful observation of human behavior, come to understand the depth and force of this motivation. They appreciate the degree to which wide swaths of society feel compelled to maintain and preserve the continuity and functionality of their information links, and the depth of the impulse to ensure that a personal communication device (such as a cell phone, smart phone, tablet, laptop computer, etc.) is charged and operational.

The inventors have observed that this impulse is particularly strong for those who are traveling on business, and those in problematic social situations, where the abundance of communication channels one might find in, e.g., an office setting, is reduced to one or two devices. In these situations, access to a crucial data point such as a delayed airplane departure, a breaking political news item, a sports outcome or a missed phone call from a client, a child, a spouse or other partner can have all the import for life success of the proverbial horseshoe nail.

At the same time, those who provide environments and accommodations to these mobile users face stiff competition for patrons and customers. They are strongly motivated to make their facilities attractive and functional, so as to entice what is often the most lucrative market segment into their businesses. They seek to develop a coherent aesthetic experience, an atmosphere, that is pleasant and inviting, and that provides every desirable resource and convenience without exposing their patrons to obtrusive reminders of the stressors that are constantly pending at the edge of consciousness.

The inventors, thus appreciating the importance of combining functionality with unobtrusive beauty, have arrived at certain new and useful inventions as further described herewith. Specifically, the inventors have come to appreciate that there is great utility to be found in a charging receptacle for a personal electronic device, where that charging receptacle is designed for discrete and aesthetically attractive placement in commercial and private establishments, localized adjacent to dining and working facilities. They have further come to understand and appreciate that combining such a charging receptacle with additional convenience features such as, for example, a coat hook, a pocketbook support, a personal device support, a luggage rack, and many other features, of which the foregoing are merely exemplary, can have great utility and benefit. They have observed that these important elements and combinations are novel. Moreover they have discovered that these inventions can have a commercial and functional significance that is surprisingly important and beneficial in ways just as unexpected and astonishing as the influence of the lost horseshoe nail.

As will be further described below, with reference to exemplary embodiments and aspects thereof, a device prepared according to the invention will include a localized electronic receptacle. In certain embodiments, this localized electronic receptacle will include a convenience feature. In certain examples, the electronic receptacle will be a USB receptacle of any known or anticipated size, and the convenience feature will be a pocketbook hook.

In one embodiment, the invention includes a system having a power supply and a plurality of charging modules. The charging modules are arranged to be more or less permanently mounted to a service location such as a bar, table, or service counter, and to be coupled to one another and to the power supply with electrical conductors. In a typical application, the power supply is engineered to receive mains power from a normal wall receptacle and convert that mains power to a regulated or unregulated voltage appropriate for charging a personal electronic device such as a cell phone, smart phone, tablet computer, laptop computer or other consumer article such as is known or may become known in the art. Power is distributed from the power supply to the charging modules over electrical conductors which are appropriately sized according to an electrical load anticipated for the number and expected utilization of the modules.

In one embodiment, each module will include a service unit including a structural member and an electronic circuit board. An exemplary structural member will include a five sided box formed of folded sheet metal, diecast metallic alloy, polymer, or other appropriate structural material. The circuit board will be mechanically coupled to the structural member and will support an electronic coupling device such as, for example (and without limitation), a USB receptacle as known in the art. In addition, certain embodiments of the invention will include an illumination device such as, for example and without limitation, a light emitting diode (LED). In a further aspect of certain embodiments, light will be conducted from the illumination device to an external surface adjacent to the coupling device by a solid-state light pipe.

In a still further aspect of certain embodiments, the module also includes a cover portion. The cover portion will be arranged to be mechanically coupled to, and supported by, the structural member of the service unit. In addition, in certain embodiments, the cover portion will be independently directly coupled to the service location with a separate fastener. In certain embodiments, two fasteners will be used to couple the service module to the service location and a third fastener will be employed to couple the cover to the service location. In various embodiments, the fasteners so employed will include one or more of a screw, a nail, an adhesive material, a bolt, and a rivet.

In still other embodiments of the invention, one or more of the service module and the cover will be coupled to the service location employing a bonding techniques such as, for example, thermal welding, arc welding, ultrasonic welding, laser welding, or any other bonding method known or that becomes known in the art.

Certain embodiments of the invention will include a cover portion including one or more hooks. The hooks will be sized and configured to support a personal article. For example, a typical hook might be well adapted to support a woman's purse or pocketbook, a man or woman's jacket, a child's coat, a briefcase, or any other personal article that would be conveniently disposed thereon while a user, for example, eats a meal or enjoys a drink at the service location.

Exemplary physical configurations and designs are illustrated in the attached figures and it will be understood that one of skill in the art, having perceived the utility of the present invention, will readily derive other valuable and serviceable configurations of the invention, all of which are intended to fall within the scope of the present disclosure.

In certain embodiments, the cover portion will exhibit a longitudinal axis, with the hook disposed adjacent to one end of the cover portion. Certain embodiments of the invention will be arranged for operative mounting with the longitudinal axis in a vertical orientation. In contrast, certain embodiments of the invention will be arranged for operative mounting with the longitudinal axis in a horizontal orientation. In other embodiments, mounting of a longitudinal axis will be made at any useful oblique angle with respect to the vertical.

In certain further embodiments, the invention includes various brackets arranged to facilitate mounting of a localized power outlet for convenience, to reduce or eliminate interference with the user seated adjacent to the localized outlet, and to minimize damage to an underlying substrate caused by installation of the device. In still further embodiments, the invention includes alternative power supplies including, for example, battery-based power supplies, allowing installation of a localized outlet remote from a mains power receptacle and without installing additional mains power connections.

The following description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed. These and other advantages and features of the invention will be more readily understood in relation to the following detailed description of the invention, which is provided in conjunction with the accompanying drawings.

It should be noted that, while the various figures show respective aspects of the invention, no one figure is intended to show the entire invention. Rather, the figures together illustrate the invention in its various aspects and principles. As such, it should not be presumed that any particular figure is exclusively related to a discrete aspect or species of the invention. To the contrary, one of skill in the art would appreciate that the figures taken together reflect various embodiments exemplifying the invention as a whole.

Correspondingly, referenced throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### BRIEF DESCRIPTION OF THE DRAWINGS

FIG. 1 shows, in perspective view, a portion of a charging system prepared according to principles of the invention;

FIG. 2 shows, in perspective view, further aspects of an exemplary charging system prepared according to principles of the invention;

FIG. 3 shows, in perspective view, details of a localized outlet of a charging system prepared according to principles of the invention;

FIG. 4 shows, in perspective view, details of an additional localized outlet of a charging system prepared according to principles of the invention;

FIG. 5 shows, in superior perspective view, details of a localized outlet of a charging system prepared according to principles of the invention;

FIG. 6 shows, in perspective view, further details of a localized outlet for a charging system prepared according to principles of the invention;

FIG. 7 shows, in perspective view, still further details of a localized outlet of a charging system prepared according to principles of the invention;

FIG. 8 shows, in perspective view, additional features of a localized outlet of a charging system prepared according to principles of the invention;

FIG. 9 shows, in perspective view, further aspects of a localized outlet for a charging system prepared according to principles of the invention;

FIG. 10 shows, in flow diagram form, an exemplary method of installation of a portion of a charging system prepared according to principles of the invention;

FIG. 11 shows, in perspective view, aspects of an exemplary bracket mounted localized outlet for a charging system prepared according to principles of the invention;

FIG. 12A shows, in lateral view, further aspects of an exemplary bracket mounted localized outlet for a charging system prepared according to principles of the invention;

FIG. 12B shows, in perspective view, further aspects of an exemplary bracket mounted localized outlet for a charging system prepared according to principles of the invention

FIG. 13 shows, in perspective view, further aspects of a localized outlet for a charging system prepared according to principles of the invention;

FIG. 14 shows, in side view, further aspects of a bracket mounted localized outlet of a charging system prepared according to principles of the invention;

FIG. 15A shows, in oblique perspective view, a bracket for a charging system prepared according to principles of the invention;

FIG. 15B shows, in oblique perspective view, aspects of a further bracket for a charging system prepared according to principles of the invention;

FIG. 16 shows, in side elevation view, further aspects of a bracket for a charging system prepared according to principles of the invention;

FIG. 17 shows, in cutaway perspective view, further aspects of a bracket for a charging system prepared according to principles of the invention;

FIG. 18 shows, in cutaway perspective view, still further aspects of a bracket for a charging system prepared according to principles of the invention;

FIG. 19 shows, in cutaway perspective view, portions of a charging system prepared according to principles of the invention;

FIG. 20 shows, in schematic perspective cutaway view, further portions of a charging system prepared according to principles of the invention;

FIG. 21 shows, in cutaway perspective view, further aspects of a charging system prepared according to principles of the invention;

FIG. 22 shows, in perspective view, an exemplary localized outlet for a charging system prepared according to principles of the invention;

FIG. 23 shows, in perspective view, further aspects of a localized outlet for a charging system prepared according to principles of the invention;

FIG. 24 shows, in perspective view, still further aspects of a localized outlet for a charging system prepared according to principles of the invention;

FIG. 25 shows, in perspective view, further aspects of a localized outlet for a charging system prepared according to principles of the invention;

FIG. 26 shows, in perspective view, an exemplary localized outlet for a charging system prepared according to principles of the invention;

FIG. 27 shows, in perspective view, aspects of a localized outlet for a charging system prepared according to principles of the invention;

FIG. 28 shows, in perspective view, further aspects of a localized outlet for a charging system prepared according to principles of the invention.;

FIG. 29 shows, in cutaway perspective view, still further aspects of a localized outlet prepared according to principles of the invention;

FIG. 30 shows, in schematic perspective view, an exemplary localized outlet for a charging system prepared according to principles of the invention;

FIG. 31 shows, in perspective view, further aspects of a localized outlet for a charging system prepared according to principles of the invention;

FIG. 32 shows, in perspective view, further aspects of a localized outlet for a charging system prepared according to principles of the invention;

FIG. 33A and 33B show, in perspective view, different aspects of a localized outlet for a charging system prepared according to principles of the invention;

FIG. 34A-34C show, in perspective view, various applications of a charging system prepared according to principles of the invention;

FIG. 35 shows, in perspective view, an exemplary localized outlet for a charging system prepared according to principles of the invention;

FIG. 36 shows, in perspective view, a further exemplary localized outlet for a charging system prepared according to principles of the invention;

FIG. 37 shows, in perspective view, still another exemplary localized outlet for a charging system prepared according to principles of the invention;

FIG. 38 shows, in perspective view, an exemplary application of a charging system prepared according to principles of the invention;

FIG. 39 shows, in perspective view, a portion of a charging system prepared according to principles of the invention;

FIGS. 40A and 40B show, in schematic block diagram form, exemplary circuits for a charging system prepared according to principles of the invention; and

FIG. 41 shows further aspects of a charging system prepared according to principles of the invention.

### DETAILED DESCRIPTION

This description is provided to enable any person skilled in the art to make and use the disclosed inventions and sets forth the best modes presently contemplated by the inventors of carrying out their inventions. In the following description, for purposes of explanation, numerous specific details are set forth in order to provide a thorough understanding of the present invention. It will be apparent, however, to one skilled in the art that the present invention may be practiced without these specific details. In other instances, well-known structures and devices are shown in schematic form in order to avoid unnecessarily obscuring the substance disclosed.

In the course of the present disclosure, the terms substantially and generally will be used to modify various descriptions. The term substantially is intended to mean within the normal manufacturing tolerances, as such would be understood by one of skill in the art, for an item of a comparable nature at the time of manufacture. The term generally is intended to imply less precision than substantially, rather to simply suggest that a particular characteristic would be perceived by the ordinary viewer examining the item. As such, an item that generally exhibits a characteristic may also substantially exhibit that characteristic, but need not. Conversely, an item that substantially exhibits a characteristic will also generally exhibit that characteristic.

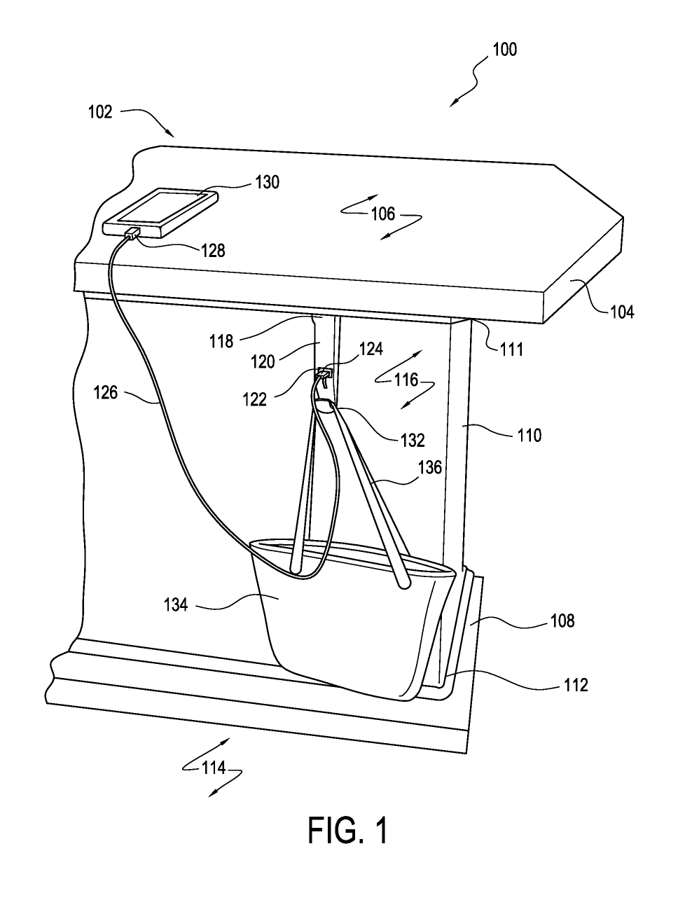

FIG. 1 shows, in perspective view, a portion of a charging system 100 for a personal communication device as employed in the context of a beverage service bar 102. One of skill in the art will readily ascertain in the figure common features of a service bar including a server 104 having a server top surface region 106, a base portion 108 disposed downwardly of the server top 106, and a pedestal portion 110 disposed between the server top surface region 106 and the base portion 108 and coupled to each at respective upper 111 and lower ends 112 thereof. The base portion 108, in turn, is supported on an upper surface region of a floor 114, which bears the weight of the service bar 102.

Coupled to, and supported by, a proximal surface region 116 of pedestal 110 is an exemplary localized outlet 118 of the charging system 100 prepared according to principles of the invention. As will be further discussed below, the illustrated localized outlet 118 includes a housing or cabinet 120 and an electronic receptacle 122. Electronic receptacle 122 is shown in use, functionally coupled to a distal end 124 of a typical charging cable 126. A proximal end 128 of the charging cable 126 is received within and coupled to a charging receptacle of a personal electronic device 130. In light of the present figure, one of skill in the art will readily appreciate that the illustrated location of the localized outlet 118 on the surface region 116 of pedestal 110 allows convenient placement of the personal electronic device 130 on surface region 106 of server 104 within the length constraints of typical charging cable 126.

In the illustrated embodiment, the localized outlet 118 also includes a convenience feature, here illustrated as a pocketbook hook 132. As illustrated in the exemplary embodiment presented, the pocketbook hook 132 is arranged and configured to support a pocketbook or other handbag 134 by a handle 136 or other coupling feature.

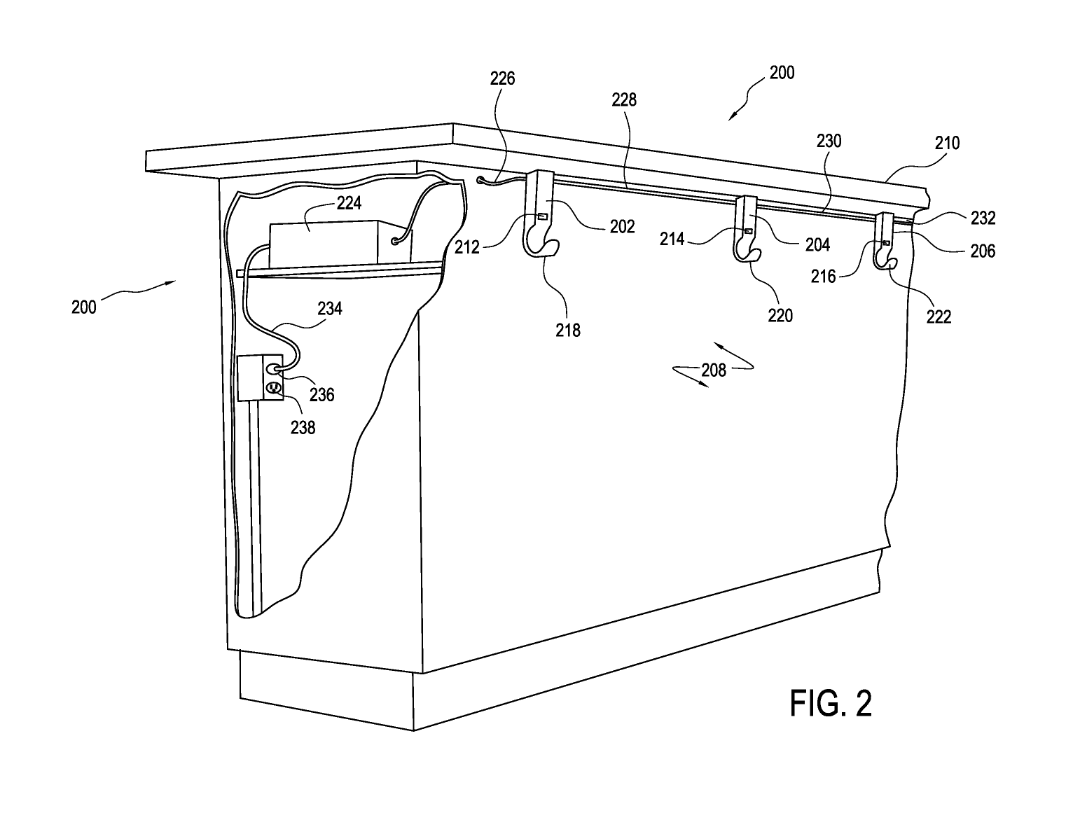

FIG. 2 shows a further aspect of an exemplary charging system 200 prepared according to principles of the invention. As shown, charging system 200 includes a plurality of localized outlets e.g., 202, 204, 206 respectively coupled to a proximal surface region 208 of a service bar 210. Each localized outlet 202, 204, 206 includes a respective electronic receptacle e.g., 212, 214, 216 and a respective convenience feature 218, 220, 222.

As illustrated, the localized outlets 202, 204, 206 are respectively electrically coupled to one another, and to a power supply module 224 in parallel daisychain configuration by a plurality of electrical conductors e.g., 226, 228, 230, 232. It will be appreciated, however, that the configuration shown is merely exemplary, and that other electrical configurations including, for example, series coupling arrangements, star coupled arrangements, and other arrangements known in the art or yet to be discovered, are intended to be included within the scope of the present disclosure.

In one embodiment of the invention, the power supply module 224 includes a power cord 234 with a standard plug 236. The standard plug 236 is adapted to be coupled to, and receive power from, a mains power receptacle 238. Naturally, the mains power receptacle will supply electrical voltage and current at levels determined according to local convention.

In certain embodiments, the power supply module 224 will convert mains power to the specific voltage to be output at, and common to, all of the electronic receptacles, e.g., 212, 214, 216. Thus, for example, where the electronic receptacle is a standard Universal Serial Bus (USB) receptacle each conductor segment 226, 228, 230, 232 will provide a voltage substantially equal to 5.0 V (generally within the tolerance of the USB standard). Accordingly, the conductor segments 226, 228, 230, 232 will include conductors sized to sustain the current anticipated in the event that a full complement of localized outlets are operated at full load, plus an increment for a safety factor.

In other embodiments, the power supply module 224 will be arranged and configured to receive mains power and output to the conductor segments 226, 228, 230, 232 an alternative voltage that differs both from the mains supply voltage received at receptacle 238, and from the output voltage supplied to devices at electronic receptacles 212, 214, 216. In such embodiments, the localized outlets 202, 204, 206 would generally each include a power conversion device capable of receiving as an input the alternative voltage and producing an output voltage required to correctly supply the respective electronic receptacles 212, 214 and 216 (which output voltage may be the same or different as between the various electronic receptacles).

For example, in certain embodiments, the alternative voltage will be an intermediate voltage. Thus, for example, the intermediate alternative voltage will, in certain embodiments, be chosen to have a relatively safe value, as opposed to mains voltage, while still being substantially above the voltage output at the electronic receptacles 212, 214, 216. Consequently, it will be possible to more readily stabilize the output voltage of the electronic receptacles 212, 214, 216. In addition, as will be understood by one of skill in the art, smaller conductors (i.e. smaller diameter) may be used in the conductor segments 226, 228, 230, 232 compared to those that would be necessary if a lower voltage (e.g., output voltage) were supplied by the power supply module 224 directly to the outputs of electronic receptacles 212, 214, 216.

One of skill in the art will appreciate that a variety of standard values are likely to be desirable from a commercial perspective as intermediate voltages. Thus, for example, in certain embodiments of the invention, an intermediate voltage supply between the power supply module 224 and respective power conversion devices will have a value of, for example, 6 V, 9 V, 12 V, 24 V, 32 V and 48 V. Again, these values are merely exemplary, and a wide variety of other alternative voltages will be employed in respective embodiments according to the requirements of a particular application and circumstance. Thus the intermediate voltage will, in certain embodiments, fall within a range between mains voltage and 0 V. Likewise, in certain embodiments the intermediate voltage will be an alternating current (AC) voltage and in other embodiments, the intermediate voltage will be a direct current (DC) voltage.

It will also be appreciated that in certain embodiments an alternative voltage higher than the mains voltage will be employed. While less common, such a configuration remains within the scope of the present disclosure.

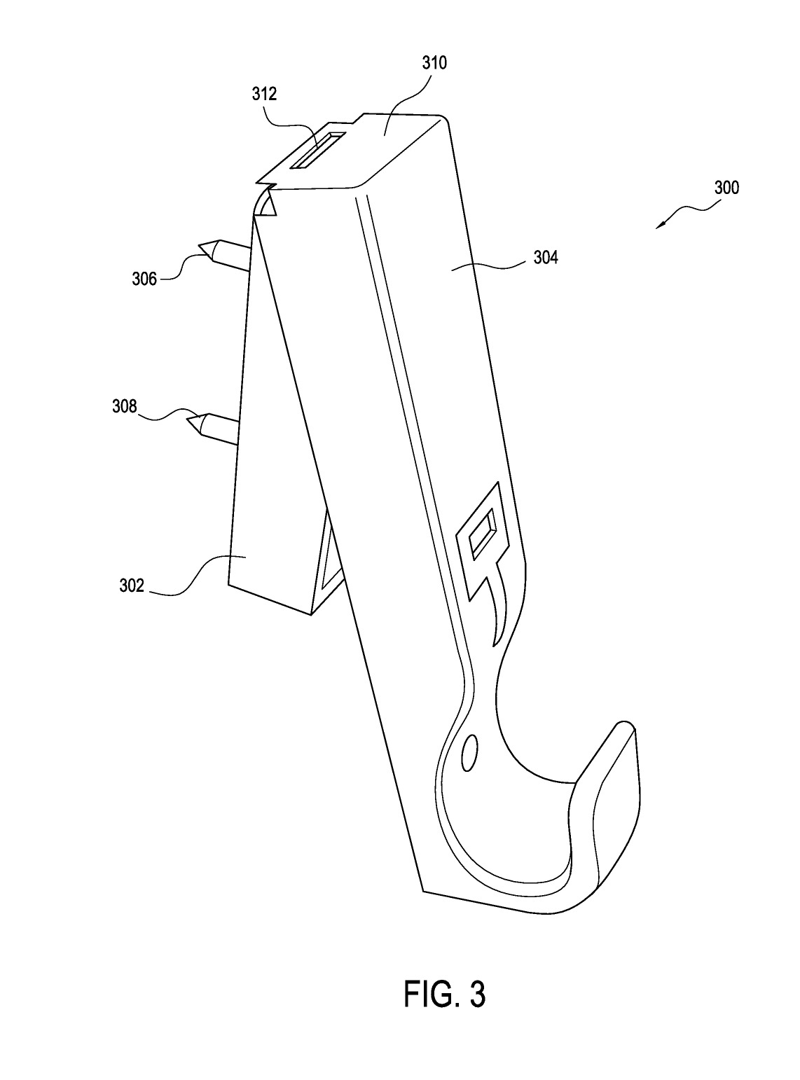

FIG. 3 shows, in perspective view, details of one embodiment of a localized outlet 300 prepared according to principles of the invention. The localized outlet 300 includes a service module 302 and a cover module 304. Among other features, the service module 302 includes first and second apertures (not visible) arranged and configured to receive respective first 306 and second 308 fasteners therethrough. The fasteners, which may be any fastener appropriate to a particular application that is known or becomes known in the art will, in various embodiments, include (without limitation) a wood screw, a metal screw, a bolt, a lag bolt, a nail, a barbed nail or a rivet. One of skill in the art will appreciate that, in certain embodiments, the function of the fastener will be served instead by an adhesive such as a physical adhesive or a chemical adhesive, or by weldment (such as, electrical weldment, a gas weldment, a laser weldment, or an ultrasonic weldment) or any other fastening method that is known or becomes known in the art.

The cover module 304 includes an upper surface region 310 with an aperture 312. The aperture 312 is arranged and configured to receive a protrusion (not shown) correspondingly located on an upper surface region of the service module 302. As will be further described below, this coupling allows for a substantially fixed connection to be effected between the service module 302 and the cover module 304 after mounting and wiring of the service module 302.

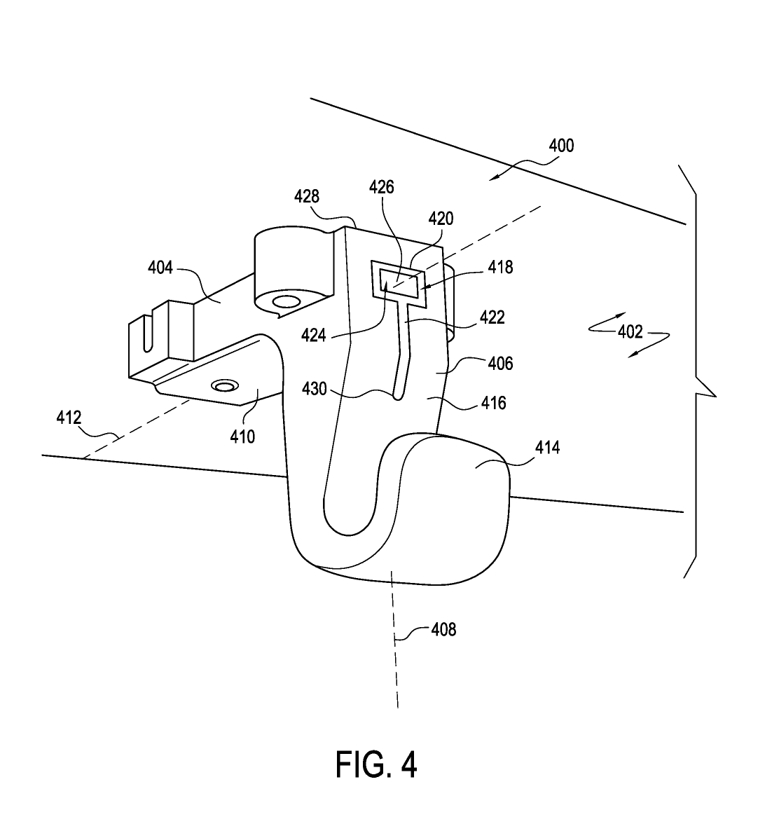

FIG. 4 shows, in perspective view, certain features of a further embodiment of the invention including a localized outlet 400. Localized outlet 400 is configured for mounting to a generally downwardly facing generally horizontal surface 402. Accordingly, localized outlet 400 is an example of a lateral localized outlet.

Lateral localized outlet 400 includes a body portion 404. Body portion 404 includes, for example, a proximal body region 406 having a generally vertical longitudinal axis 408 and a distal body region 410 having a generally horizontal longitudinal axis 412, where proximal and distal are defined with respect to a user.

In certain embodiments, body region 406 includes a convenience feature. In the illustrated embodiment, the convenience feature of body region 406 is a hook feature 414. A proximal surface region 416 of body region 406 includes an aperture 418. In the illustrated embodiment, the aperture 418 is defined by a generally T-shaped border 420. Within the T-shaped border 420 is disposed a generally T-shaped bezel 422. The bezel 422 includes a further aperture 424. Within the further aperture 424 is disposed, in the exemplary embodiment, a charging receptacle such as, for example, a USB receptacle 426.

In certain embodiments, the proximal body region 406 includes a proximal body cavity therewithin extending from an upper edge 428 downward at least as far as the lower end 430 of the generally T-shaped bezel 422. In certain embodiments, the bezel 422 will include a translucent or transparent material. In some such embodiments, an illumination source such as, for example, an LED, is placed within the proximal body cavity. Light emitted from the illumination source can then pass through the bezel 422 to assist in positioning of the USB receptacle 426, for product identification, and for ornamental effect.

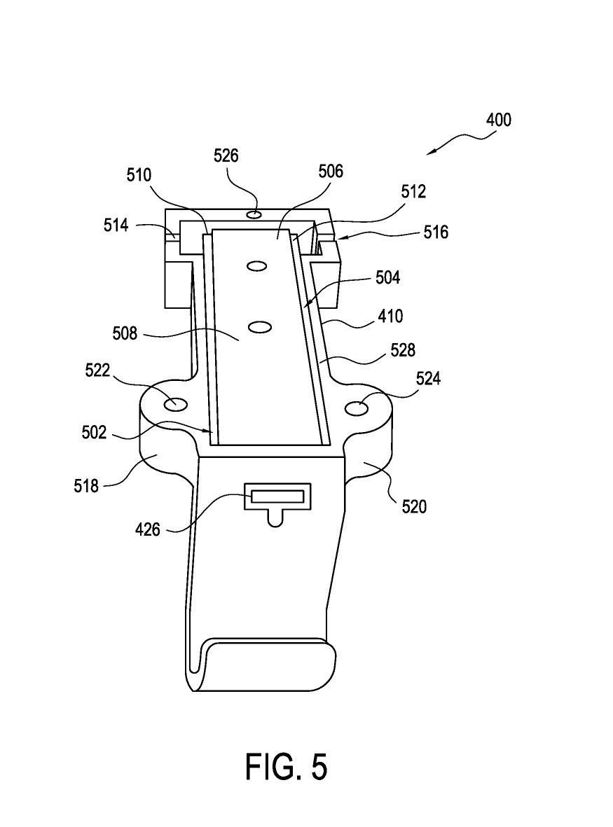

FIG. 5 shows a further view of the localized outlet 400. In this view, it is apparent that the proximal body cavity 502 extends upward and backward into the distal body region 410. That is, the distal body region 410 includes a distal body cavity 504 which is contiguous with the proximal body cavity 502.

Disposed within the proximal 502 and distal 504 body cavities is a power conversion device 506. The power conversion device 506 includes a printed circuit board 508. Various components are operatively coupled to the printed circuit board 508 and, together, effect the power conversion function of power conversion device 506.

In the illustrated embodiment, the various components include the USB receptacle 426. It should be noted that, in the illustrated embodiment, many of the various components are mounted inwardly of the printed circuit board 508, within the distal body cavity 504, and an upper surface of the printed circuit board is generally aligned with an upper edge 528 of the distal body region 410. With reference to FIG. 3, it will be understood that, in other embodiments of the invention, an upper surface of a service module, similar to service module 302, will be generally aligned with an upper edge 528 of the distal body region 410.

In certain embodiments, and as illustrated in FIG. 5 the power conversion device 506 includes first 510 and second 512 terminal blocks. The terminal blocks 510, 512 are arranged and configured to be connected to daisychain supply wiring (not shown) which provides input power to the power conversion device 506. In the illustrated embodiment, various components are coupled to a lower surface region of the printed circuit board 508. Because of this arrangement, with the exception of the USB receptacle 426 and the terminal blocks 510, 512, the various components are not visible in FIG. 5.

As illustrated, the distal body region 410 includes first 514 and second 516 slots and/or apertures. The slots and/or apertures 514, 516 are adapted to receive portions of the daisychain supply wiring when surface mounted supply wiring is employed. Certain embodiments also include mounting lugs 518, 520, and mounting holes 522, 524, 526. The mounting holes 522, 524 and 526 are sized and adapted for receiving fasteners therethrough.

The fasteners, which may be any fastener appropriate to a particular application that is known or becomes known in the art will, in various embodiments, include (without limitation) a wood screw, a metal screw, a bolt, a lag bolt, a nail, a barbed nail or a rivet. One of skill in the art will appreciate that, in certain embodiments, the function of the fastener will be served instead by an adhesive such as a physical adhesive or a chemical adhesive, or by weldment (such as, electrical weldment, a gas weldment, a laser weldment, or an ultrasonic weldment) or any other fastening method that is known or becomes known in the art.

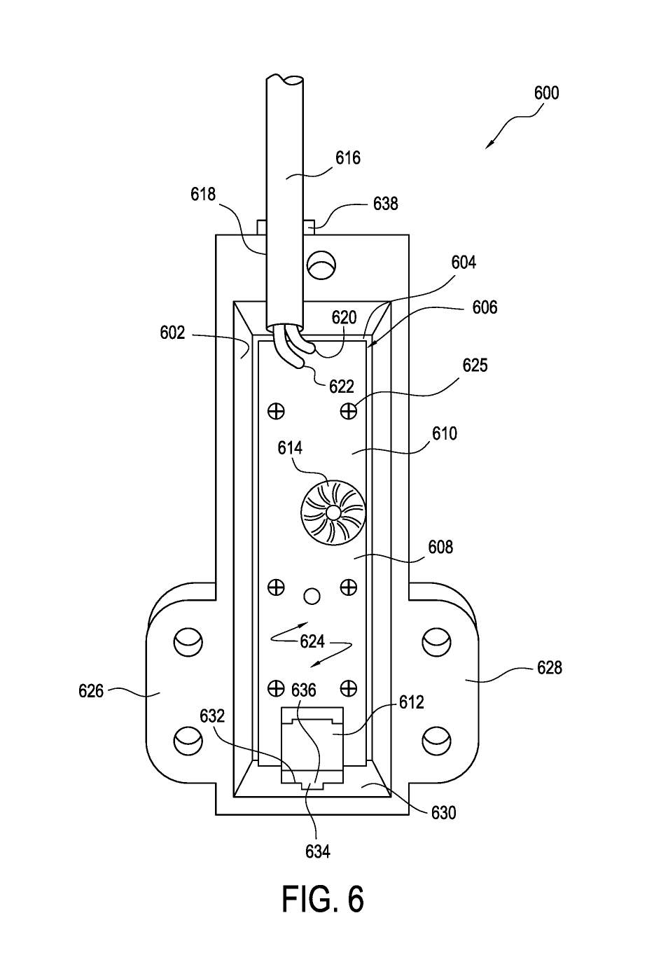

FIG. 6 shows, in plan view, a further embodiment of a localized outlet 600 prepared according to principles of the invention. As illustrated, localized outlet 600 includes generally vertical internal surface regions, e.g., 602, and generally horizontal internal surface regions, e.g., 604, which together define an internal cavity 606.

Within the internal cavity 606 is disposed a power conversion device 608 including various electronic components, e.g. a printed circuit board 610, a USB receptacle device 612 and an electronic choke 614. In the illustrated embodiment, a power supply pigtail 616 passes through a groove and/or aperture 618 between the internal cavity 606 and a spatial region external to the localized outlet 600. The power supply pigtail device includes, for example, two or more electrical conductors, e.g. 620, 622 which are respectively operatively coupled to the power conversion device for supplying it with electrical current.

In the illustrated embodiment, the various components are coupled to an upper (as usually oriented during operation) surface 624 of the printed circuit board 610. This contrasts with the orientation visible in the embodiment 400 of FIG. 5, and allows the printed circuit board 610 to be fastened to, and supported by, internal surface region 604. In the illustrated embodiment, fasteners e.g., 625 are shown as employed to affect this connection. It will be appreciated, however, that alternative fastening apparatus and methods will be used in corresponding embodiments of the invention.

One of skill in the art will appreciate that the arrangements and orientations of components presented in these illustrations are merely exemplary of a wide variety of such arrangements that will be employed in corresponding embodiments of the invention.

Similarly, the mounting lugs 518, 520 shown in the illustration of FIG. 5 each has a single hole 522, 524 for receiving respective fasteners. In contrast, the mounting lugs 626 and 628 of the FIG. 6 embodiment 600 each has two holes for receiving fasteners. One of skill in the art will, once again, understand that a wide variety of such configurations are intended to be represented by the present disclosure and are intended to be considered as aspects of the present invention.

Also visible in FIG. 6 is a distal internal surface region 630 having a generally vertical orientation. From the illustrated perspective, a portion of a bezel 632 is visible

disposed within an aperture of surface region 630. In certain embodiments, the bezel 632 will include a tab portion 634 having a tab distal surface region 636. In addition, certain embodiments will include a strain relief device 638 to support the power supply pigtail 616.

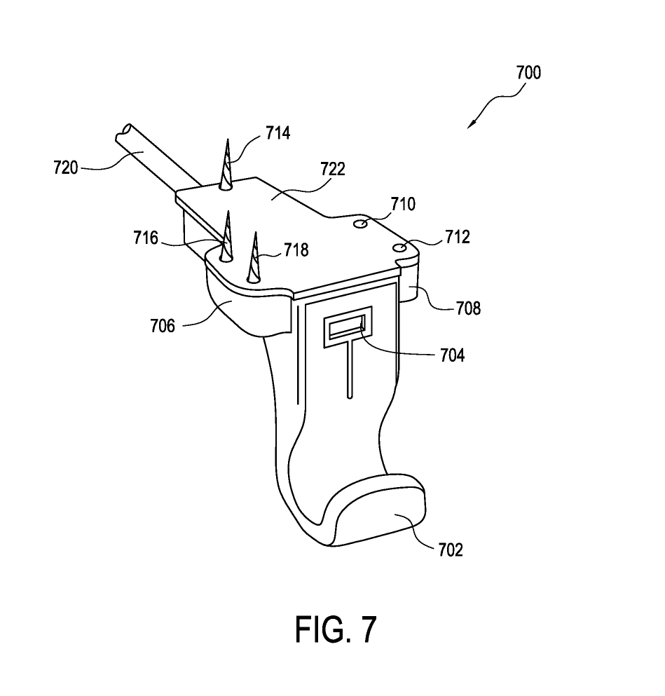

FIG. 7 shows a further distal perspective view of the localized outlet 700 similar to that illustrated in FIG. 6. Visible is a hook feature 702, an aperture and USB receptacle 704, first 706 and second 708 mounting lugs with respective fastener holes, e.g. 710, 712, exemplary fasteners 714, 716, 718, a power supply pigtail 720, and an exemplary cover element 722.

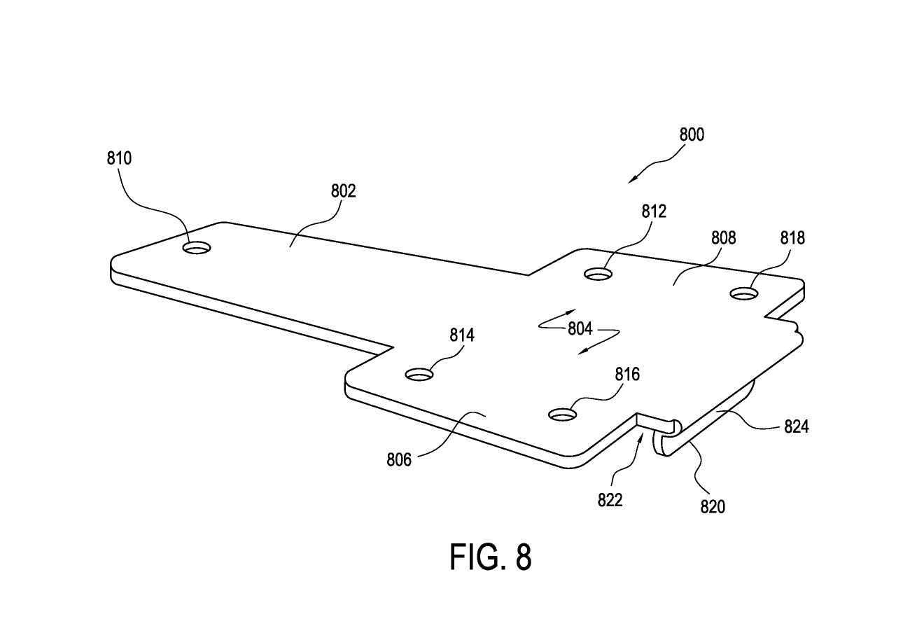

FIG. 8 shows a cover element 800 like that of FIG. 7 in additional detail. In the embodiment shown, cover element 800 includes a sheet metal member 802 having a generally planar upper surface 804 and first 806 and second 808 flange regions. One of skill in the art will appreciate that the illustrated through-holes 810, 812, 814, 816, 818 are aligned and configured to receive the fasteners employed to attach the body of the localized outlet to an under-surface of a supporting piece of furniture or architectural element. Consequently, when in use, the cover is disposed between the body of the localized outlet and the under-surface.

In the illustrated embodiment, the cover element 800 includes a projecting lip 820 disposed downwardly from a lower surface region 822 thereof. The projecting lip 820 includes a proximal (from the perspective of a user) surface region 824. The proximal surface region 824 is arranged and configured to be disposed in contact with a corresponding distal surface region of an internal cavity of a localized outlet body portion such as, for example, surface region 630 (as shown in FIG. 6) so as to help align the cover element 800 with the balance of the localized outlet 600 and hold the cover element and the body of the localized element in generally fixed spatial relation to one another.

In still other embodiments, the projecting lip 820 will be shaped and configured to extend downwardly and interfere with a distal surface region e.g., 636 of a bezel element so as to urge the bezel element in a proximal direction and, thereby, tend to retain the bezel element within its aperture in the proximal wall of the localized outlet 600. Still other embodiments of the cover element 800 will omit the projecting lip 820.

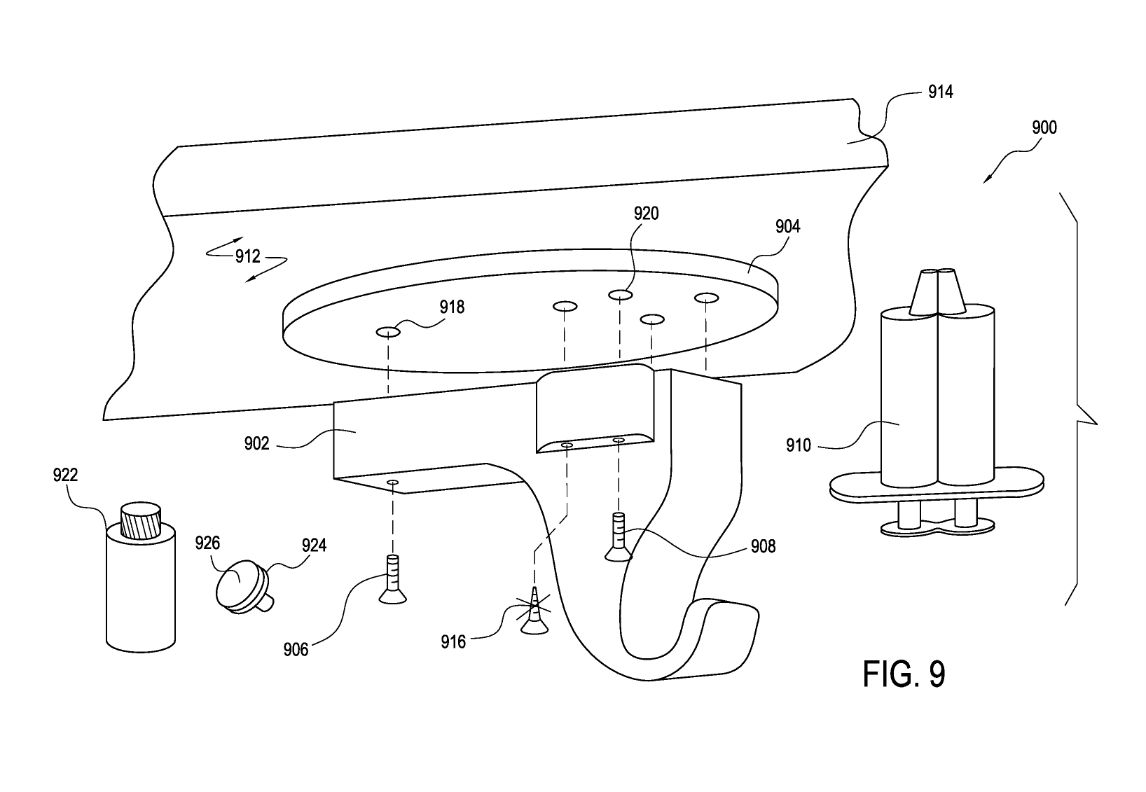

FIG. 9 shows, in perspective view, a further aspect of the invention, including a mounting kit 900 for a lateral localized power outlet 902. In the illustrated embodiment, the mounting kit 900 includes a mounting plate 904, a plurality of fasteners e.g., 906, 908 and an adhesive material 910.

The mounting kit 900 allows the robust attachment of the localized power outlet 902 to a surface 912 of a substrate 914. This can be particularly useful in circumstances where, for example, a wood screw (see, e.g., 916) typically used for mounting the localized power outlet 902 is anticipated to form an insufficiently strong coupling to the substrate.

The mounting kit 900 will also find application where the exemplary wood screw 916 would be unreasonably difficult to install (as, for example, where the mounting substrate includes a relatively impenetrable material such as granite, marble, glass, steel, or other metallic, tough or fragile material). In such circumstances, the mounting kit 900 will allow reliable mounting of the localized power outlet 902 by adhesive attachment of the mounting plate 904 to the substrate surface 912.

In the illustrated embodiment, the mounting kit 900 includes a two-part adhesive 910 such as, for example, an epoxy adhesive including a resin portion and a catalyst hardener portion. In certain alternative embodiments, silicone-based adhesives will be beneficially employed. In still other embodiments, cyanoacrylate based adhesives will be employed. Accordingly, one of skill in the art will readily understand that this representation is intended to encompass any adhesive or other bonding method appropriate to a particular application whether that adhesive is known in the art or yet to be developed. It is also intended to encompass adhesive tapes or any other adhesive material, including adhesive materials protected by a release strip prior to application.

After adhesive attachment of the mounting plate 904 to the substrate surface 912, a plurality of machine screws 906, 908 (or other appropriate fasteners or fastening means, as exemplified above) will be used to couple the localized power outlet 902 to the mounting plate 904 by, for example, threaded coupling with corresponding internally threaded bores, e.g., 918, 920. The robust material of the mounting plate provides a secure receptacle for receiving the fasteners and ensures strong attachment between the localized power outlet 902 and the mounting plate 904. Likewise, the large surface area of the mounting plate and the choice of an appropriate adhesive ensures a strong bond between the mounting plate 904 and the substrate 914.

In certain embodiments, the localized power outlet 902 will be fastened to the mounting plate 904 prior to adhesive attachment of the mounting plate 904 to substrate surface 912. In still other embodiments of the invention, the localized power outlet 902 will be formed and/or shipped as an integral unit with the mounting plate 904.

In certain embodiments, the mounting kit 900 will include an appropriately packaged cleaning solution 922. In certain embodiments, the mounting kit will also include a cleaning pad 924. In certain embodiments, the cleaning pad 924 will include a textile material 926. In still further embodiments, the cleaning solution package will include an integrated cleaning pad.

One of skill in the art will appreciate that the mounting kit 900 will, in certain embodiments, be sold as a separate add-on or customization item, or may be included with a standard complement of localized power outlets. In still other embodiments, the mounting kit 900 will be employed by, for example, a furniture manufacturer in advance of furniture sale. Accordingly, furniture will be received by an end-user with a mounting plate pre-attached to the furniture in anticipation of the later installation of a localized power outlet.

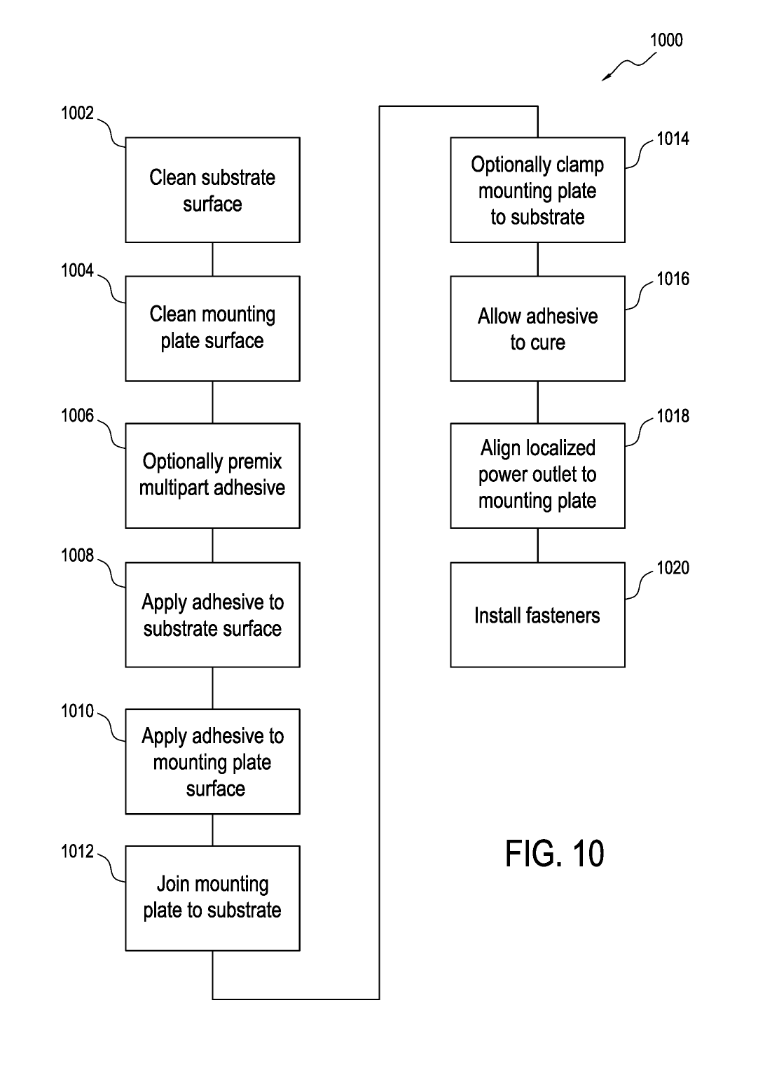

FIG. 10 shows, in flow diagram form, an exemplary method 1000 for installing a mounting kit similar to mounting kit 900 of FIG. 9. The method 1000 includes a step 1002 of cleaning a surface region of a mounting substrate (e.g. 912). The method 1000 also includes a step 1004 of cleaning a surface region of the mounting plate (e.g., 904). Where the adhesive to be employed includes a multipart adhesive, the method 1000 includes a step 1006 of pre-mixing the multipart adhesive. Thereafter, the adhesive material is applied to one or both of the substrate surface region 1008 and the mounting plate surface region 1010. It will be appreciated by one of skill in the art, that certain adhesives will be applied according to methods preferred for those adhesives. Thus, for example, a cyanoacrylate adhesive may be applied to one of the two surfaces, while an accelerator/catalyst is applied to the other surface.

In step 1012 the mounting plate surface is brought into contact with the substrate surface. Where appropriate to the particular adhesive, a clamping apparatus will be applied 1014 to temporarily maintain the two surfaces in contact while the adhesive cures. In certain embodiments of the invention, an appropriate clamping apparatus will be included in the mounting kit 900.

Thereafter, the adhesive is allowed to cure 1016. As discussed above, where the localized power outlet is not preassembled to the mounting plate, the localized power outlet is thereafter aligned to the mounting plate 1018 and fasteners are installed 1020 to complete coupling of the localized power outlet to the mounting plate.

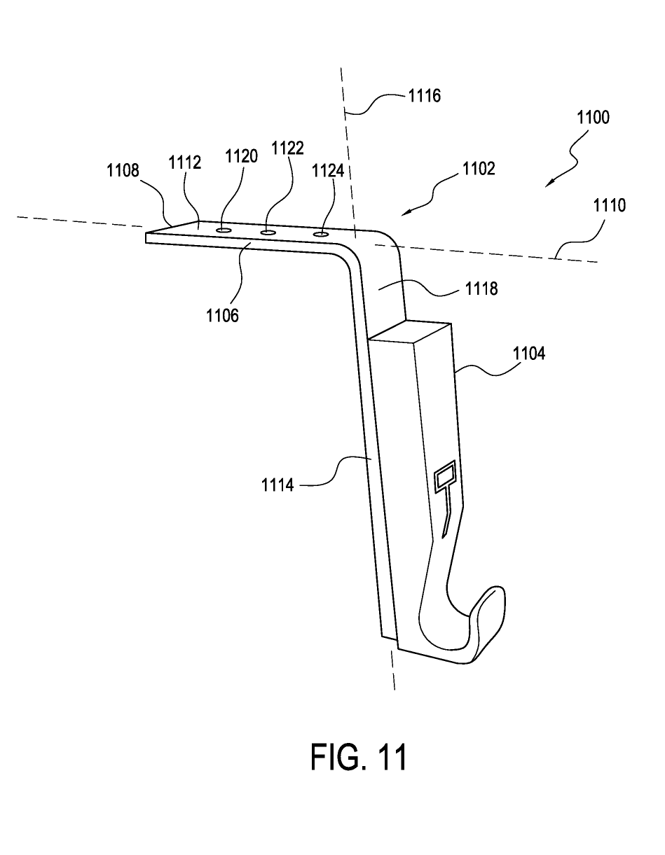

FIG. 11 shows, in perspective view, a further aspect of the invention including a bracket mounted localized outlet 1100. As illustrated, the bracket mounted localized outlet includes a mounting bracket 1102 and a localized outlet 1104. One of skill in the art will appreciate that, whereas a lateral localized outlet as exemplified by e.g., localized outlet 400 will have advantages in certain circumstances, the ability to employ a localized outlet configured for vertical mounting (as shown e.g. in FIG. 3 as outlet 300) will have commercial and functional benefits. In particular, the ability to employ a single configuration of outlet for both vertical and horizontal mounting will, in certain circumstances, allow a reduction in inventory costs, documentation overhead, certification costs, etc. Accordingly, it will be appreciated that in the bracket 1102 will offer significant economic benefits in some conditions.

As illustrated, bracket 1102 includes a structural member 1106 having a first portion 1108 with a first longitudinal axis 1110 and a first outer surface region 1112. Structural member 1106 includes a second portion 1114 with a second longitudinal axis 1116 and a second outer surface region 1118. It will be noted that, while portion 1108 is shown projecting rearward, bracket 1102 may equally well be employed with portion 1108 projecting forward.

A first plurality of holes, e.g., 1120, 1122, 1124 is disposed through surface region 1112, generally perpendicular thereto. The first plurality of holes is sized to accommodate mounting screws for placement therethrough. One of skill in the art will readily appreciate that such mounting screws will be applied at a lower surface of a mounting substrate (or, for example, to a mounting plate as illustrated 904 in FIG. 9).

In certain embodiments, one or more additional mounting holes (not shown) are provided through surface 1118 for coupling localized outlet 1104 to bracket 1102. In certain embodiments the one or more additional mounting holes include internal threads for receiving corresponding mounting screws. In other embodiments, localized outlet 1104 is coupled to bracket 1102 by alternative fasteners or fastening apparatus such as, for example, rivets, adhesives, or weldments. In still other embodiments of the invention, bracket 1102 is manufactured to include features of a service module such as service module 302 of FIG. 3.

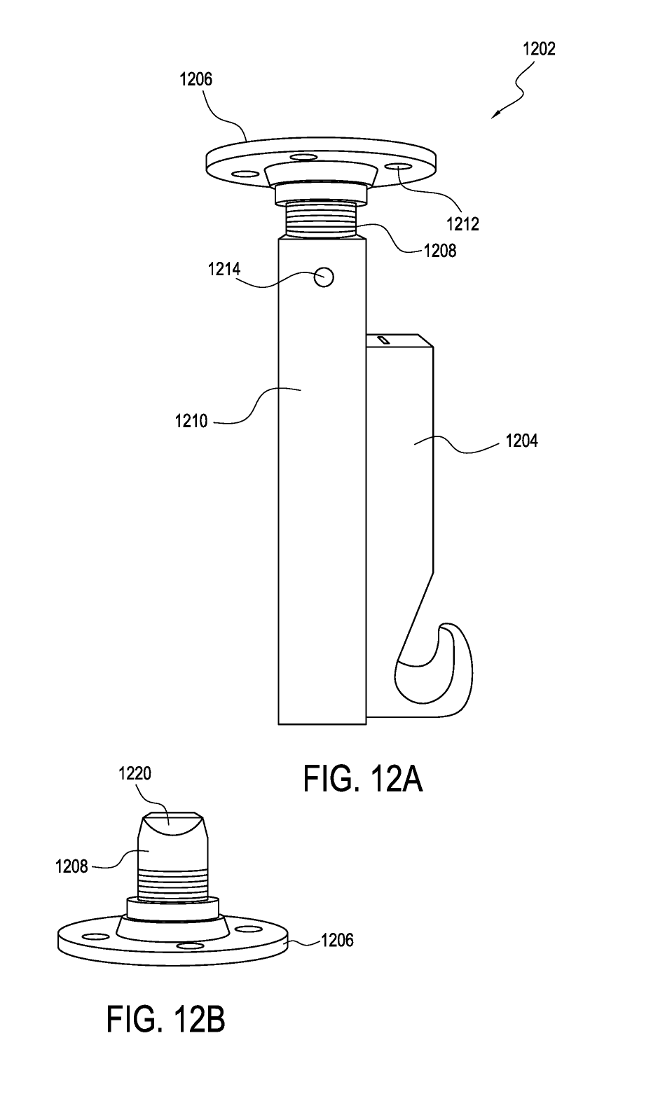

FIG. 12A shows, in perspective view, a further bracket mounted localized outlet 1200, including a mounting bracket 1202 and a localized outlet 1204. Bracket 1202 includes a first flange portion 1206 a second coupling portion 1208 and a third tubing portion 1210. In the illustrated embodiment, the tubing portion includes a rectangular tubing. In certain embodiments, the coupling portion 1208 will include a section of iron pipe and the tubing portion 1210 will include a square tubing material.

As illustrated, the flange portion will include one or more mounting holes, e.g., 1212 configured and arranged to receive mounting screws therethrough. In certain embodiments, both the tubing portion and the coupling portion will include aligned through holes and a fastener, such as, e.g., a roll pin 1214, will be disposed through the through hole to ensure a substantially permanent connection between the tubing portion and the coupling portion.

FIG. 12B shows, in perspective view a detail of bracket 1202 including flange portion 1206 and coupling portion 1208. As illustrated, coupling portion 1208 includes a plurality of facets, e.g., 1220 at an end distal to flange 1206. The facets are arranged and configured to facilitate insertion of the coupling portion 1208 into the tubing portion 1210. One of skill in the art will understand that, with the aid of such facets, a beneficial press fit between the coupling portion 1208 and 1210 will be achievable. The facets will, in various embodiments, be formed by grinding, sanding, machining, molding, forging, or any other process appropriate to produce the desired configuration. In certain embodiments, a conical facet will be provided to fit, for example, within a tubing portion 1210 of generally elliptical or circular cross-section.

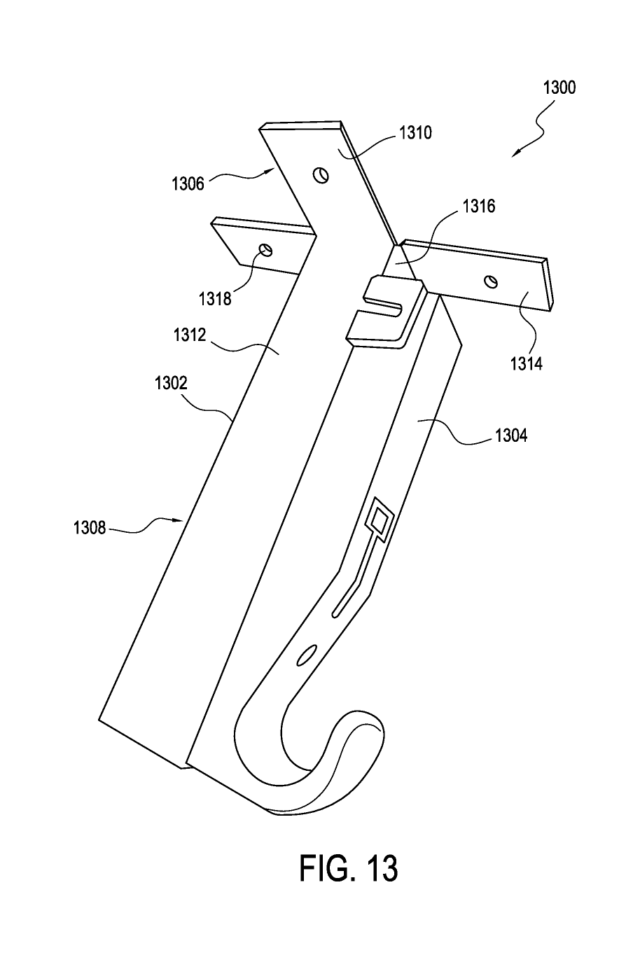

FIG. 13 shows, in perspective view, a further bracket mounted localized outlet 1300, including a mounting bracket 1302 and a localized outlet 1304. Bracket 1302 includes a first flange portion 1306 and a second tubing portion 1308. In the illustrated embodiment, the tubing portion includes a rectangular tubing. In certain embodiments the rectangular tubing portion will include a square tubing material.

One of skill in the art will understand that the flange portion 1306 is formed by separating and bending the sides of the tubing portion 1308. Consequently, and as will be readily apparent, exemplary flange 1310 is contiguous with and formed from side 1312 of tubing portion 1308. Likewise, exemplary flange 1314 is contiguous with and formed from side 1316 of tubing portion 1308.

As illustrated, the flange portion will include one or more mounting holes, e.g., 1318 configured and arranged to receive mounting screws therethrough. Desirably, each flange will include at least one mounting hole. In certain embodiments, one or more flanges will include a plurality of mounting holes. Additionally, although not visible in FIG. 13, certain embodiments of the bracket 1302 will include one or more mounting holes on side 1316 for receiving machine screws, or other fasteners, for coupling localized outlet 1304 to bracket 1302.

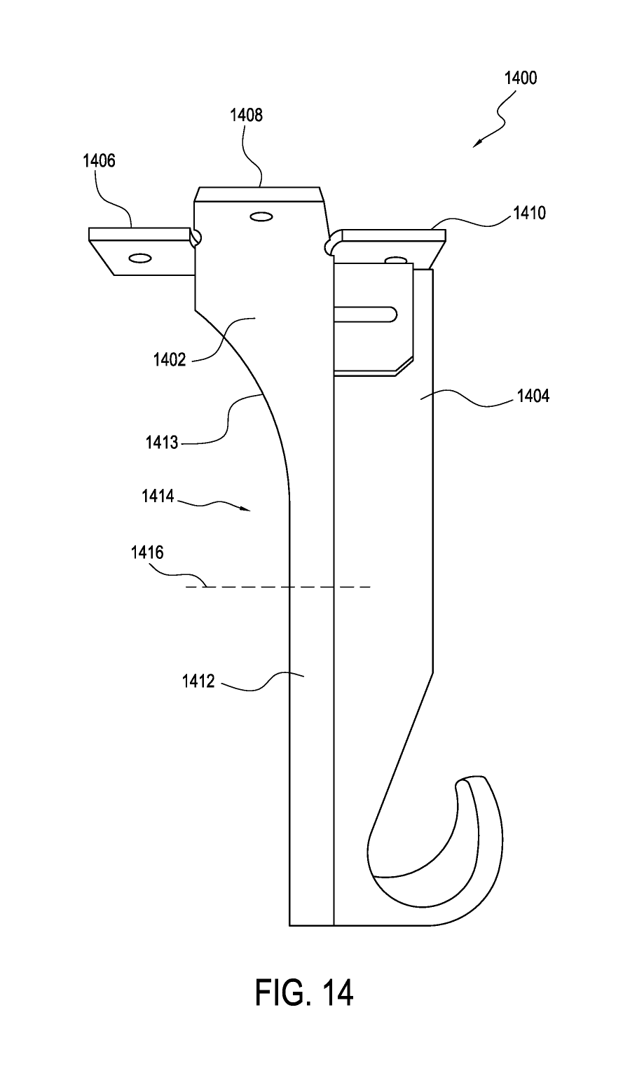

FIG. 14 shows, in side view, a further example of a bracket mounted localized outlet 1400, including a mounting bracket 1402 and a localized outlet 1404. As with bracket 1302, bracket 1402 includes a plurality of folded flanges, e.g., 1406, 1408, 1410. A square (or rectangular) tubing portion 1412 of bracket 1402 includes a curved edge 1413 and a relieved portion 1414, such that a cross-section of bracket 1402 taken at plane 1416 has a u-channel profile.

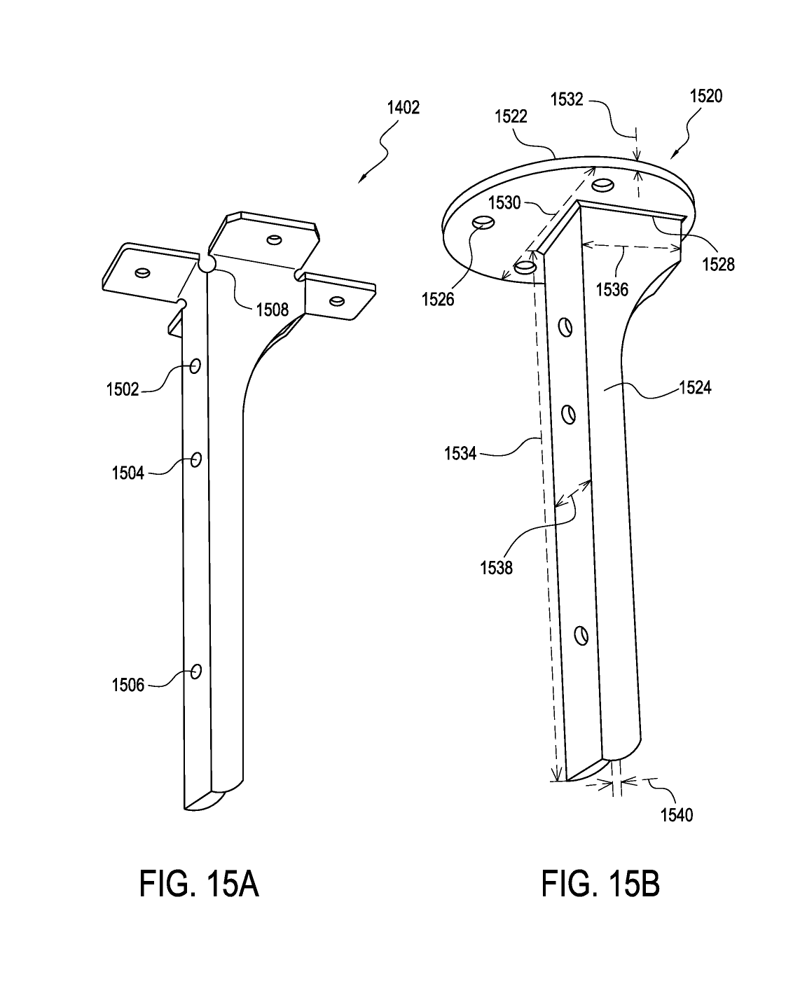

FIG. 15A shows a further aspect 1500 of bracket 1402 in an oblique perspective view. In aspect 1500, exemplary internally threaded mounting holes 1502, 1504 and 1506 are visible. One of skill in the art will appreciate that clearance holes will also be used in respective embodiments of the invention along with, for example, one more of machine screws and internally threaded nuts, self righting screws and rivets.

Also visible in FIG. 15A are relief profile regions, e.g. 1508. In one embodiment, the invention includes a manufacturing method wherein relief holes are drilled diagonally into the corners of the tubing and mounting holes are drilled and tapped into a surface for receiving housing mounting machine screws. Optionally thereafter, in certain embodiments, a portion of the square tubing is removed in an arcuate pattern or other geometric or random pattern to slim the bracket, leaving the corresponding remaining portion of the bracket in a u-channel shape. Thereafter, the tubing is sawn diagonally to release the flanges and, thereafter, the flanges are bent into position, substantially perpendicular to their original orientation, with or without preheating of the metal to facilitate bending.

FIG. 15B shows a further embodiment 1520 of a bracket prepared according to principles of the invention. Bracket 1520 includes a first flange portion 1522 and a second tubing portion 1524. As illustrated, bracket portion 1522 exhibits one or more mounting holes, e.g., 1526. In the illustrated embodiment, both flange portion 1522 and tubing portion 1524 are formed of a metallic material such as, for example, aluminum.

The tubing portion 1524 is substantially permanently connected to the flange portion 1522 by, for example, a welding process at a weldment 1528. While it will be understood that various embodiments of the present invention will be made at any appropriate scale, and there is no intention to limit such size or scale in the present disclosure, in at least one embodiment, a diameter 1530 of flange portion 1522 is at least about 3 inches; a thickness 1532 of flange portion 1522 is at least about 0.125 inches. A length 1534 of tubing portion 1524 is at least about 6.25 inches; a transverse dimension 1536 of tubing portion 1524 is at least about 1.25 inches, as is a further transverse dimension 1538; and a wall thickness 1540 of tubing portion 1524 is at least about 0.125 inches.

In considering bracket 1520 of FIG. 15B, one of skill in the art will readily understand that the square tubing of tubing portion 1524 will, in alternative embodiments, be replaced by, for example, flat stock of appropriate dimensions, circular tubing, circular tubing having a flattened portion, elliptical tubing, triangular tubing, or tubing or material of any other cross-section appropriate to the indicated function.

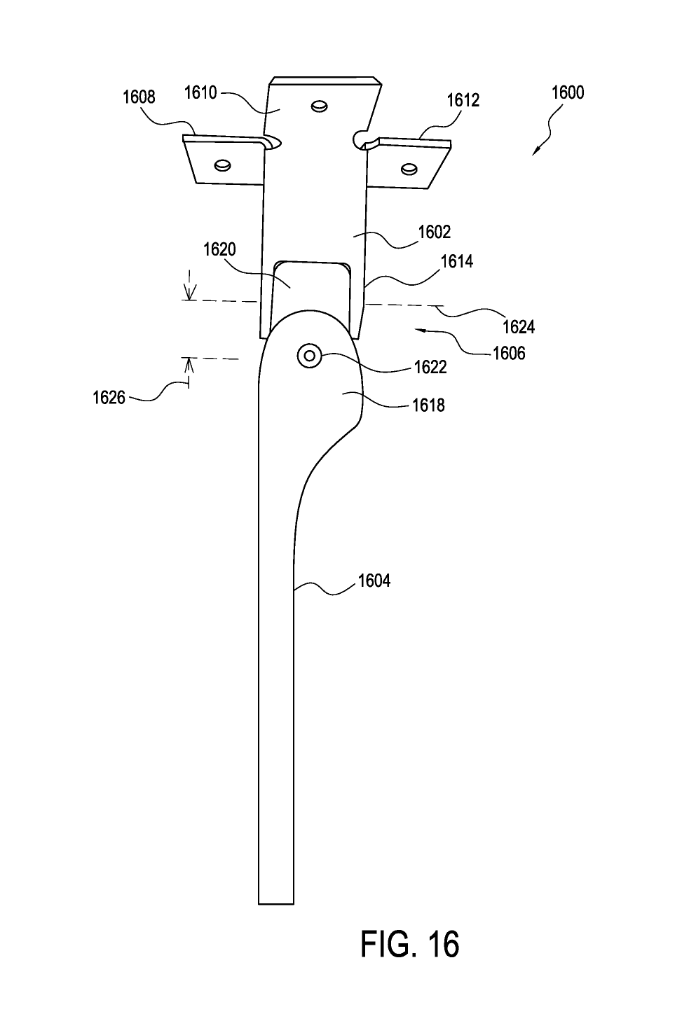

FIG. 16 shows, in side elevation, a further example of a bracket 1600 for a bracket mounted localized outlet. Bracket 1600 includes a flange element 1602, a housing mount element 1604, and a universal joint element 1606.

The flange element 1602 includes a plurality of flanges e.g., 1608, 1610, 1612 like those of the previously described brackets (e.g., those of FIG. 15A). Similarly, the housing mount element 1604 includes a mounting surface (not shown) and, in some embodiments, a plurality of mounting holes like those of the previously described brackets.

The universal joint element 1606 allows the housing mount element 1604, and a localized outlet mounted to it, to be readily displaced so as to avoid any injury to a user. Thus, for example, when the bracket 1600 is mounted under a table, if the user's leg strikes the bracket and localized outlet, they move readily away without bothering the user.

One of skill in the art will be familiar with the concept of a universal joint (otherwise known as a Hooke's joint) from the field of rotary power transmission. In the presently illustrated embodiment, the universal joint element 1606 includes a first yoke portion 1614, a second yoke portion 1618 and a cross piece portion 1620 along with a first axle 1622 and a second axle (not shown) aligned coaxially with a rotary axis 1624.

In the illustrated cross piece portion 1620, the axes of rotation of the first 1622 and second axles are displaced from one another 1626. In alternative embodiments of the invention, however, these axes will be coplanar. The requisite corresponding modifications of the yoke geometry will be readily apparent to one of skill in the art.

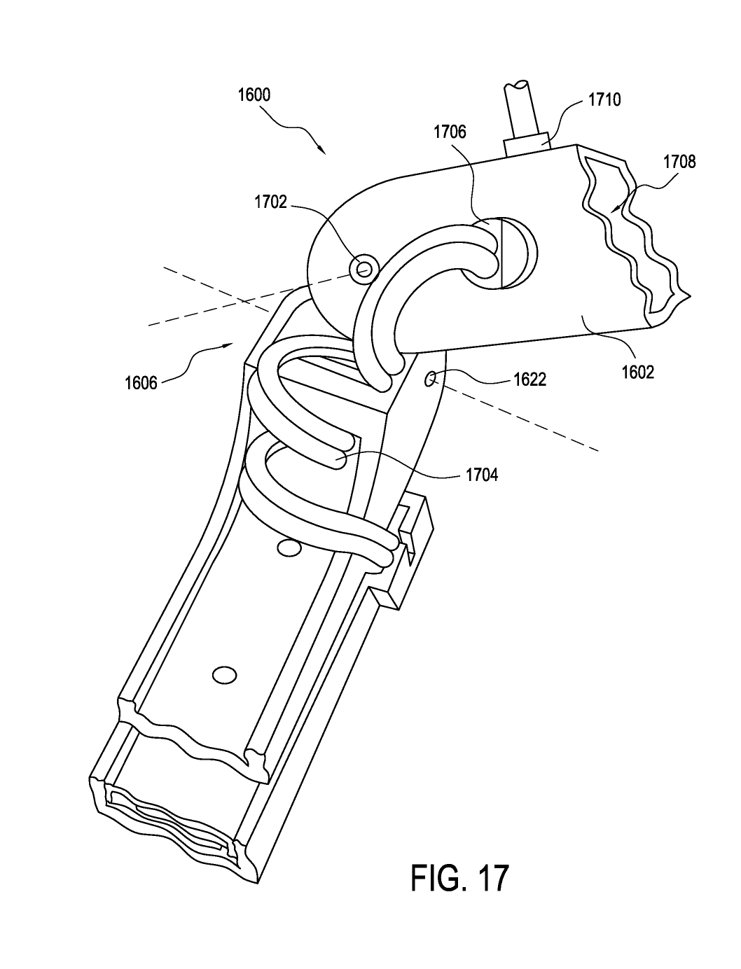

FIG. 17 shows, in cutaway perspective view, a further aspect of the bracket 1600, including additional detail of the universal joint element 1606. In particular, both axles 1622 and 1702 are visible. In the illustrated embodiments, the axles 1622 and 1702 include spring tension roll pins, but one of skill in the art will appreciate that a wide variety of alternative axles will be employed in respective embodiments of the invention. For example, the axles will, in certain embodiments, be formed of one or more of metallic and nonmetallic shaft material, machine screws and lock nuts, rivets, and any other appropriate material.

Also shown in FIG. 17 is an electrical power supply pigtail 1704. In the illustrated embodiment, the pigtail 1704 is disposed in a coil configuration so as to allow flexibility to avoid disrupting operation of the universal joint element 1606. Also in the illustrated embodiment the pigtail 1704 is supported at an aperture of the flange element 1602 by a strain relief device 1706.

In the illustrated embodiment, the electrical power supply pigtail passes through a hollow interior region 1708 of the flange element 1602 and back out of the flange element 1602 at a further strain relief device 1710. One of skill in the art will really appreciate that, the illustrated arrangement may be substituted with other arrangements in which, for example, the pigtail is captured by a single wraparound strain relief device (i.e., a cable clamp) affixed to an external surface of the flange element 1602 so that the pigtail does not pass through the interior region of the flange element 1602.

One of skill in the art will appreciate that, while bracket 1600 of FIGS. 16 and 17 is shown to include a universal joint element 1606, a variety of other devices will be beneficially employed to provide similar displacability of the localized outlet. Accordingly, in certain embodiments of the invention, the function of the universal joint will be provided by a linear or helical spring of metallic, polymeric or other material, an elastomeric spring in the configuration of a convoluted boot, a pneumatic spring, a ball and socket joint, a flexible cord such as a textile cord or a cord of natural or synthetic elastomeric polymer, or a replaceable breakaway element including, for example, a plastic, crystalline sugar or wax material. Also employed in various embodiments of the invention and according to principles of the invention will be a coupling of nonlinear polymeric material.

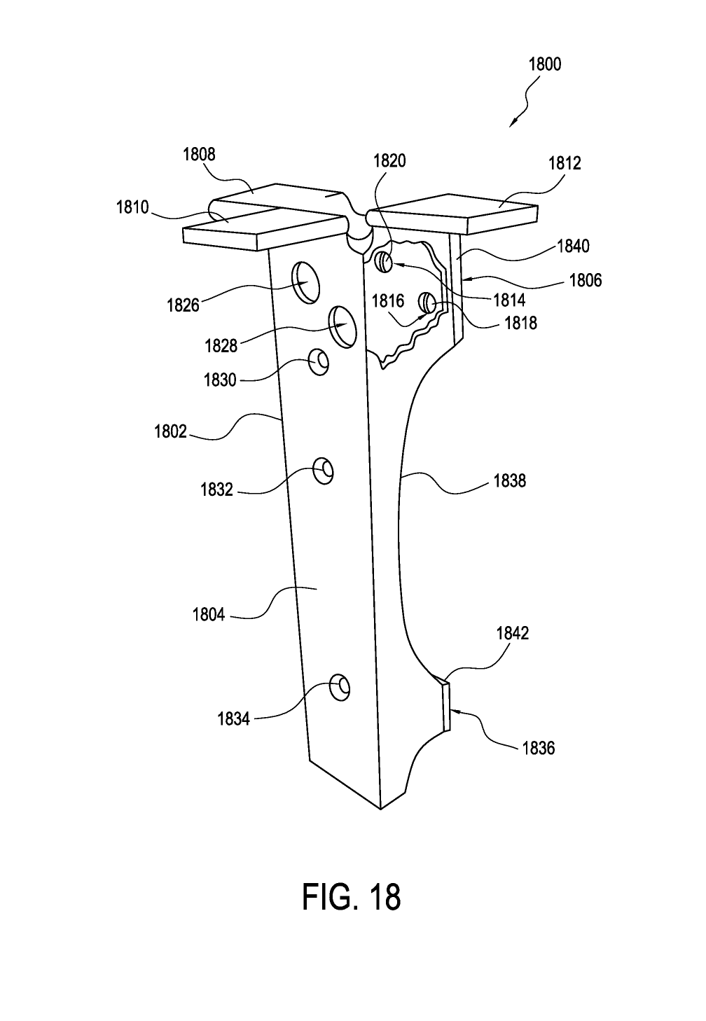

FIG. 18 shows in cutaway perspective view a further example of a bracket 1800 for a bracket mounted localized outlet. Bracket 1800 is arranged and configured to allow installation of a localized outlet (not shown) while minimizing the visibility of damage done to a mounting surface by that installation.

For comparison, in certain embodiments of the localized outlet 118 shown in FIG. 1, installation of the outlet requires penetration of the bar with a screw below the level of the USB receptacle bracket 1800. Bracket 1800 allows mounting of the same localized outlet 118 without penetrating a supporting surface except in an area immediately adjacent to, e.g., a lower surface of the bar top. Accordingly, bracket 1800 includes a body member 1802 having a front surface region 1804 and a rear surface region 1806. In the illustrated embodiment, the body member 1802 includes a portion of square tubing such as square aluminum tubing.

First 1808 second 1810 and third 1812 flanges are formed as described above. The material that would otherwise form a fourth flange has been removed, however, so that surface region 1806 can be placed in proximity to a vertical mounting surface. In certain embodiments, flanges 1808, 1810 and 1812 will include mounting holes for connection to an undersurface of a bar, etc. In other embodiments, however, such holes are omitted and the flanges merely provide stability to the bracket 1800 by being placed in contact with such an undersurface.

One or more mounting holes, e.g. 1814, 1816 are disposed through surface region 1806. The mounting holes 1814, 1816 are sized to receive mounting screws, e.g. 1818, 1820 therethrough. Access to these mounting screws 1818, 1820 for installation and removal of the bracket is available through respective apertures 1826, 1828 in surface region 1804. The diameter of the apertures 1826, 1828 is selected to be sufficiently large to allow the heads of screws 1818, 1820 (and any corresponding installation tool) to pass through.

In addition, in the illustrated embodiment, surface region 1804 exhibits internally threaded mounting holes, e.g. 1830, 1832, 1834 to support installation of the corresponding localized outlet.

A further surface region 1836 is disposed at a lower region of the body member 1802. In the illustrated embodiment, surface region 1836 as defined by a cutout 1838 which is disposed between surface region 1836 and surface region 1806.

This cutout serves to separate the supporting surface regions, thereby increasing overall stability of the bracket in some circumstances. In the illustrated embodiment, the cutout is shown as a single arcuate cutout. It will be understood, however, that alternative forms of cutout including rectangular and polygonal cutouts and cutouts providing multiple surface regions are intended to fall within the scope of the present disclosure.

Also, in the illustrated embodiment, first 1840 and second 1842 pad elements are shown disposed in substantially fix relation to surface regions 1806 and 1836 respectively. These pad elements cushion an interface between surface regions 1806 and 1836, and respective adjacent wall or furniture surface regions, thereby reducing or preventing damage the adjacent surface. In various embodiments, the pad elements 1840, 1842 will be fixed to surface regions 1806 and 1836 respectively with a chemical adhesive, a mechanical fastener, or other appropriate means known in the art.

While some of the various brackets described above have been described as if fabricated of, for example, aluminum tubing, it will be well understood by one of skill in the art that many alternative fabrication and manufacturing processes are possible including, for example, die casting, molding, machining, etc. as well as many alternative materials including, for example, alternative metallic materials, polymers and filled polymers, elastomers of appropriate durometer, and a wide variety of other materials, whether used alone or in combination.

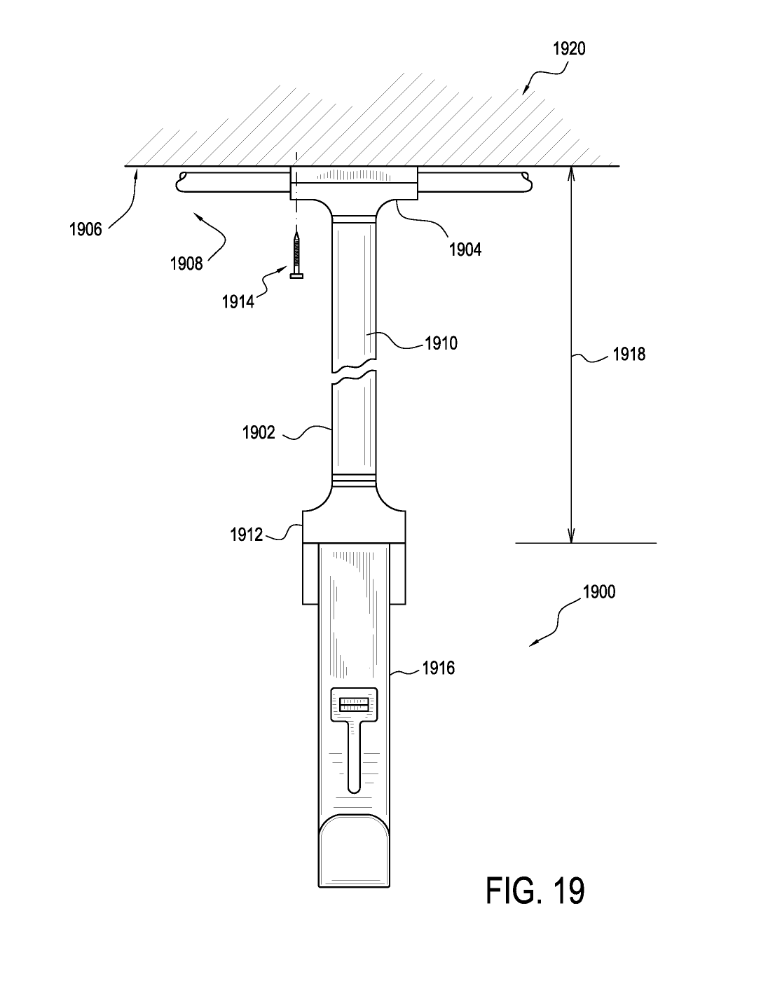

FIG. 19 shows, in schematic perspective view, a localized outlet 1900 according to principles of the invention including a mounting feature 1902. The mounting feature 1902 includes a base portion 1904 arranged to be coupled to a generally downwardly facing surface 1906, a forward the facing surface 1908, or any other appropriate supporting surface. This coupling will be achieved by any appropriate means.

In the illustrated embodiment, coupling is achieved by the installation of screws, e.g., 1914 into a lower surface of a bar or other substrate 1920. The mounting feature 1902 also includes a conduit portion 1910 and a coupling portion 1912. A housing 1916 of the localized outlet 1900 is coupled to the coupling portion 1912, which is in turn coupled to the conduit portion 1910, which is, in turn, coupled to the base portion 1904.

In certain aspects of the invention, the length 1918 of the conduit portion can be selected on a custom basis according to requirements of a particular customer. Thereafter the conduit can be assembled to the base portion 1904 and the coupling portion 1912 either prior to shipment, at a customer location or in any other convenient venue.

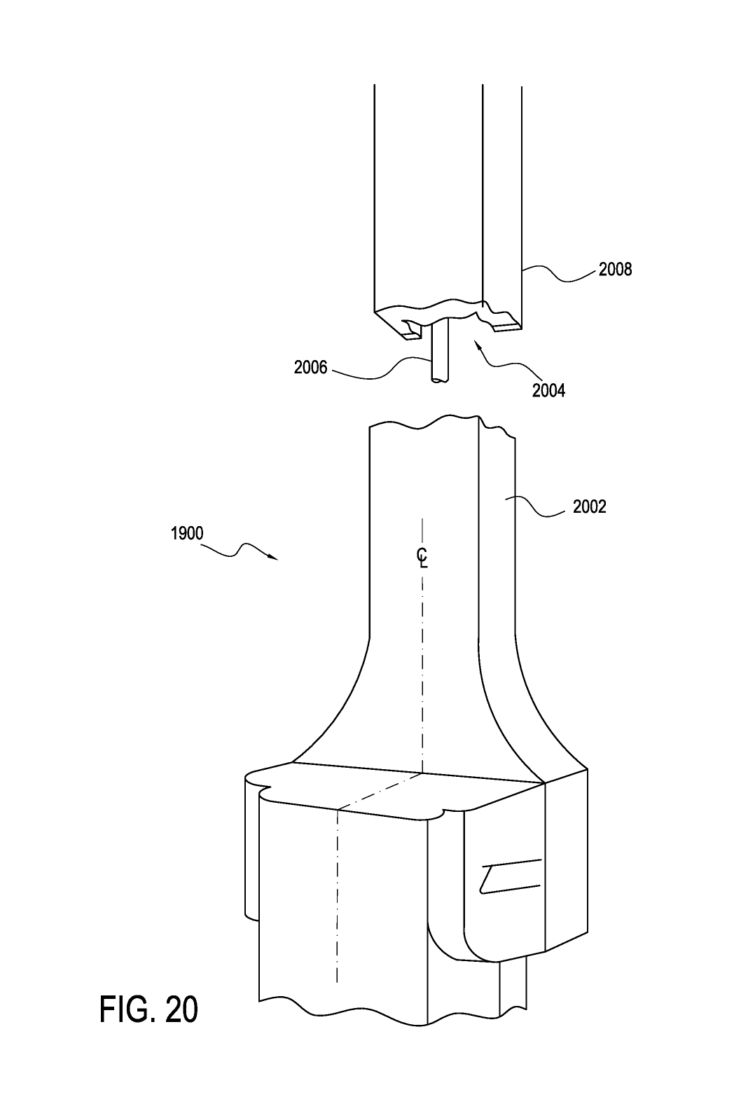

FIG. 20 shows, in schematic perspective cutaway view, further aspect of a localized outlet 1900 prepared according to principles of the invention. Illustrated are a conduit portion 2002 embodying a channel 2004. Channel 2004 is adapted and configured to receive therewithin, e.g., an electrical cable 2006 for conveying power to a power conversion device of the localized outlet 1900. In certain embodiments the conduit portion 2002 will include a non-marring surface material 2008 to prevent undesirable marking of an adjacent surface such as, e.g., the front of a bar or a wall.

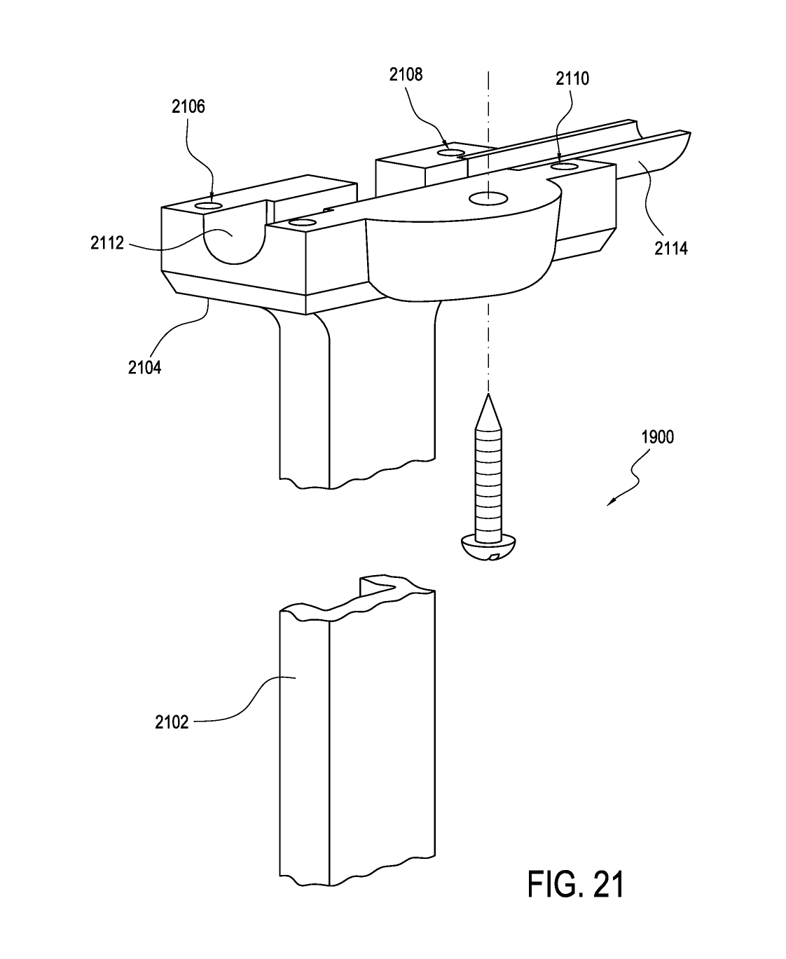

FIG. 21 shows, in perspective cutaway view, further portions of a localized outlet 1900, including a conduit portion 2102 and a base portion 2104. As illustrated, the base portion 2104 includes exemplary mounting holes, e.g., 2106, 2108, 2110, and coupling features, e.g. 2112 for coupling the base portion 2104 to a further supply conduit 2114. It will be noted that the conduit may have a cross-section that is generally circular, generally semicircular, generally polygonal (of any desired polygonal form) or of any other appropriate shape.

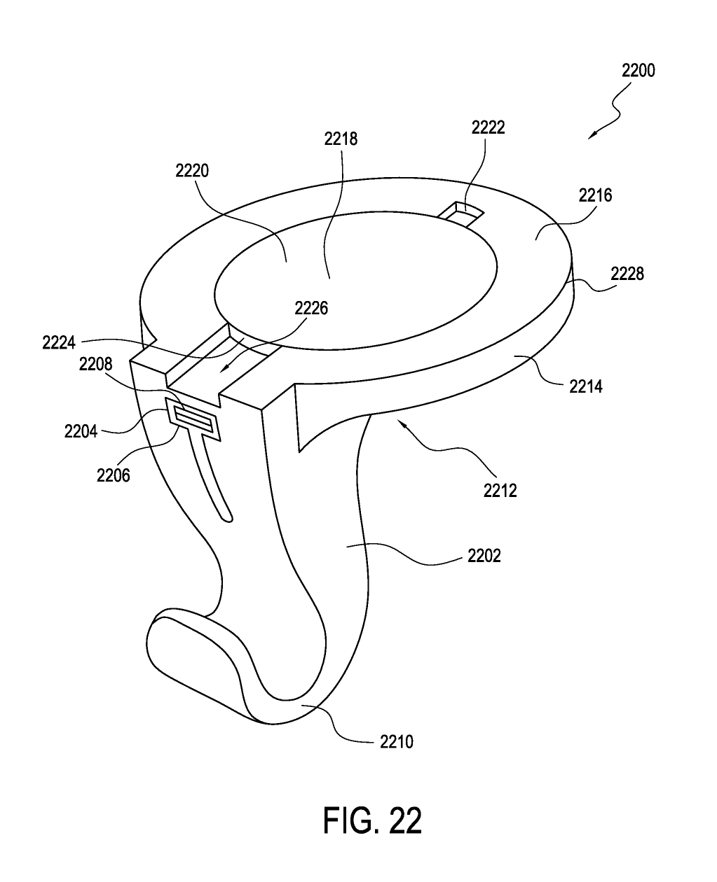

FIG. 22 shows a further embodiment of a localized outlet 2200 prepared according to principles of the invention. Localized outlet 2200 includes a generally vertical body portion 2202 having an aperture 2204 with a bezel 2206, a USB receptacle 2208, and a convenience feature such as a hook 2210, along with a horizontal body portion 2212. In addition, localized outlet 2200 includes an extended flange portion 2214.

The extended flange portion 2214 has an upper surface region 2216 which, in certain embodiments, has a generally planar aspect and is disposed in a generally horizontal orientation when in use. In certain embodiments and applications, upper surface region 2216 is arranged and configured to support a personal item such as, for example a personal electronic device (not shown). This configuration can be particularly convenient during charging of the personal electronic device as, for example, when the personal electronic device is coupled by a charging cable to the USB receptacle 2208.

In addition, in certain embodiments, the extended flange portion 2214 includes a charging coil/antenna 2218 for wireless charging of a device such as a personal electronic device. In such embodiments, a personal electronic device may be disposed adjacent to, or in spaced relation to, an upper surface region 2220 of the charging coil for wireless charging. In certain embodiments, the charging coil 2218 is operatively coupled by an electrical conductor 2222 to a power source (not shown) within a cavity in the body of the localized outlet 2200. In certain embodiments of the invention, a generally proximally oriented illuminated surface region 2224 of the charging coil is visible to a user through, for example, an aperture or groove 2226 of the localized outlet 2200.

In certain embodiments, the upper surface 2220 of the charging coil 2218 is generally fixedly disposed adjacent to a lower surface of a counter, table, or other supporting apparatus. In such a configuration, a personal electronic device having a wireless charging capability may be charged by placing it on an upper surface of the counter, table, or other supporting apparatus respectively. In such a configuration, charging takes place by the transmission of time-varying magnetic fields through the bulk material of the counter, table, or other supporting apparatus.

It will be appreciated by one of skill in the art that, while the perimeter 2228 of the extended flange portion 2214 is illustrated as having generally circular aspect, this is only one of many possible arrangements. In other embodiments, the perimeter will be any of rectangular, square, polygonal, elliptical, piecewise linear, arbitrarily curved, and combinations thereof.

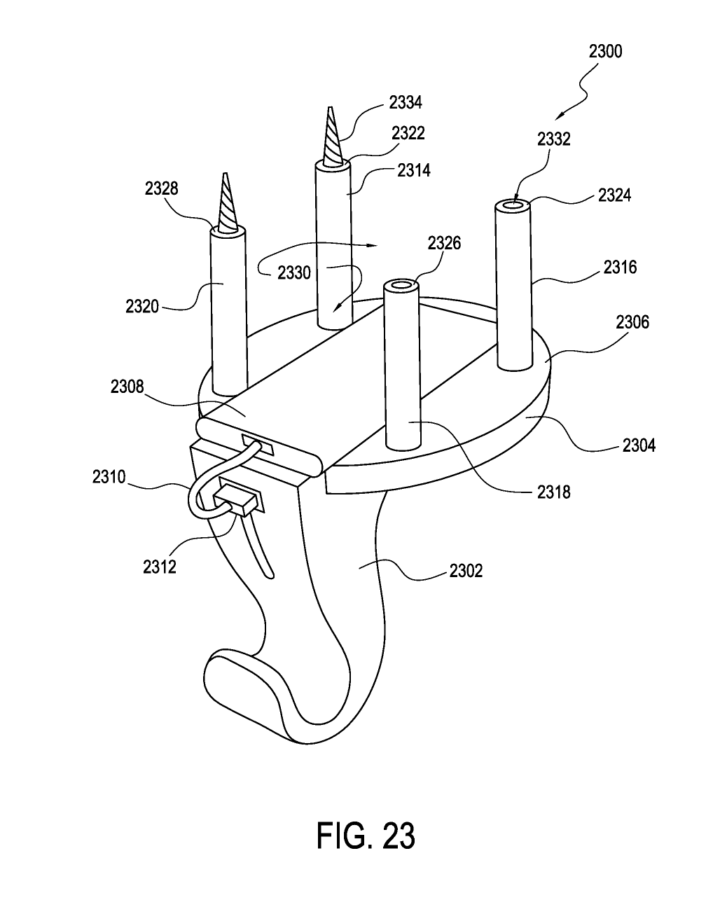

FIG. 23 shows, in perspective view, a further embodiment of a localized outlet 2300, prepared according to principles of the invention. Like the localized outlet 2200 illustrated in FIG. 22, localized outlet 2300 includes a body 2302 with an extended flange portion 2304. An upper surface region 2306 of the extended flange portion 2304 is well adapted to support, for example, a smart phone 2308 or other personal electronic device. While thus arranged, the smart phone 2308 may be recharged by wireless recharging, through inductive coupling with a recharging coil/antenna disposed, for example, within the extended flange portion 2304. Alternately, the smart phone 2308 may be recharged by wired recharging through the USB cable 2310 coupled to a USB port 2312 of the localized outlet 2300.

In certain embodiments, the extended flange 2304 will include one or more standoff mounting features, e.g, 2314, 2316, 2318, 2320. The standoff mounting features include respective upper surface regions, e.g. 2322, 2324, 2326, 2328. These upper surface regions are adapted to be disposed adjacent to, for example, a lower surface region (not shown) of an architectural feature or furniture element such as, for example, a table, a bar, a server, or other item. In such an arrangement, upper surface region 2306 of the extended flange portion 2304 is disposed in generally parallel spaced relation to the lower surface region of the architectural feature or furniture element, so as to define a spatial region 2330 within which the personal electronic device 2308 may be disposed.

One of skill in the art will understand that a wide variety of apparatus and/or methods will be used, in respective embodiments of the invention, to couple the upper surface regions 2322, 2324, 2326, 2328 to the architectural feature or furniture element. Such a coupling apparatus and/or methods will be selected according to the particular materials present and the performance characteristics desired. Thus, in the illustrated embodiment 2300, each of the standoff mounting features includes a through-hole, e.g. 2332 within which is disposed an appropriate fastener such as, for example, a wood screw, e.g. 2334.

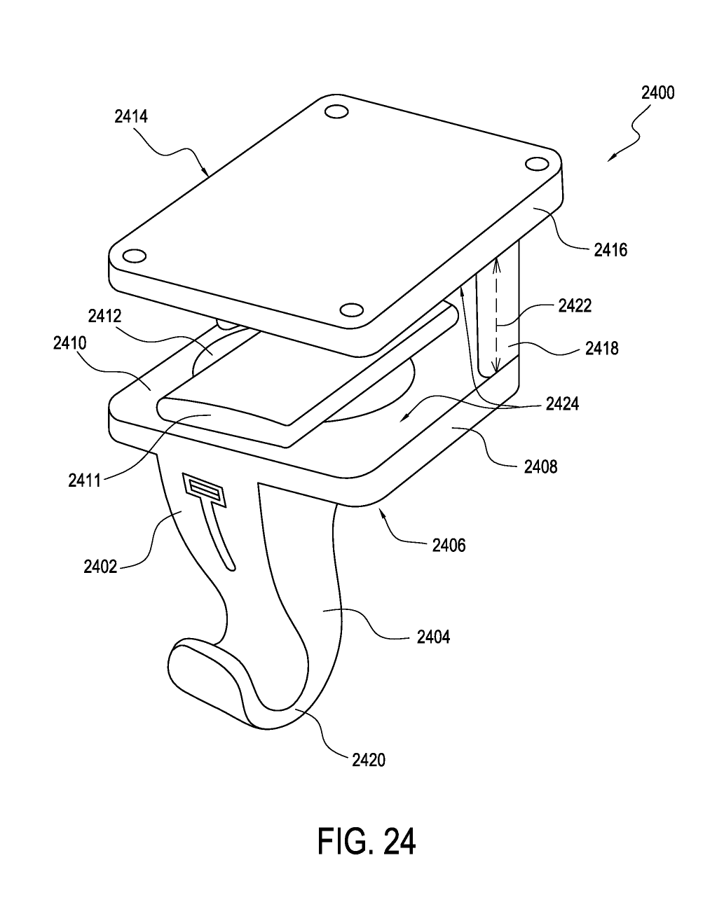

FIG. 24 shows still another embodiment of the invention, including a localized outlet 2400. Localized outlet 2400 includes a body portion 2402 having a generally vertical portion 2404, a generally horizontal portion 2406 and an extended flange portion 2408. The extended flange portion 2408 includes an upper surface region 2410 well configured to support a personal electronic device 2411 for convenience storage and/or storage during charging. In certain embodiments, the extended flange 2408 includes a wireless charging coil/antenna 2412.

Localized outlet 2400 also includes a mounting flange portion 2414. Mounting flange portion 2414 includes a coupling portion 2416 and a spacer portion 2418. The coupling portion 2416 is configured and arranged to be substantially fixedly coupled to a lower surface of an architectural feature or furniture element (not shown). The spacer portion 2418 is configured and arranged to operatively couple the extended flange portion 2408, and the balance of the body portion 2402 to the coupling portion 2416 so that a convenience feature such as, for example, hook 2420 of body portion 2402 will reliably support the weight of a hand bag, backpack, or other personal item.

It will be appreciated by one of skill in the art that a vertical dimension 2422 of the spacer portion 2418 will be chosen, according to a desired application, to form a desirable spatial region 2424 within which a personal electronic device 2411 may be conveniently stored.

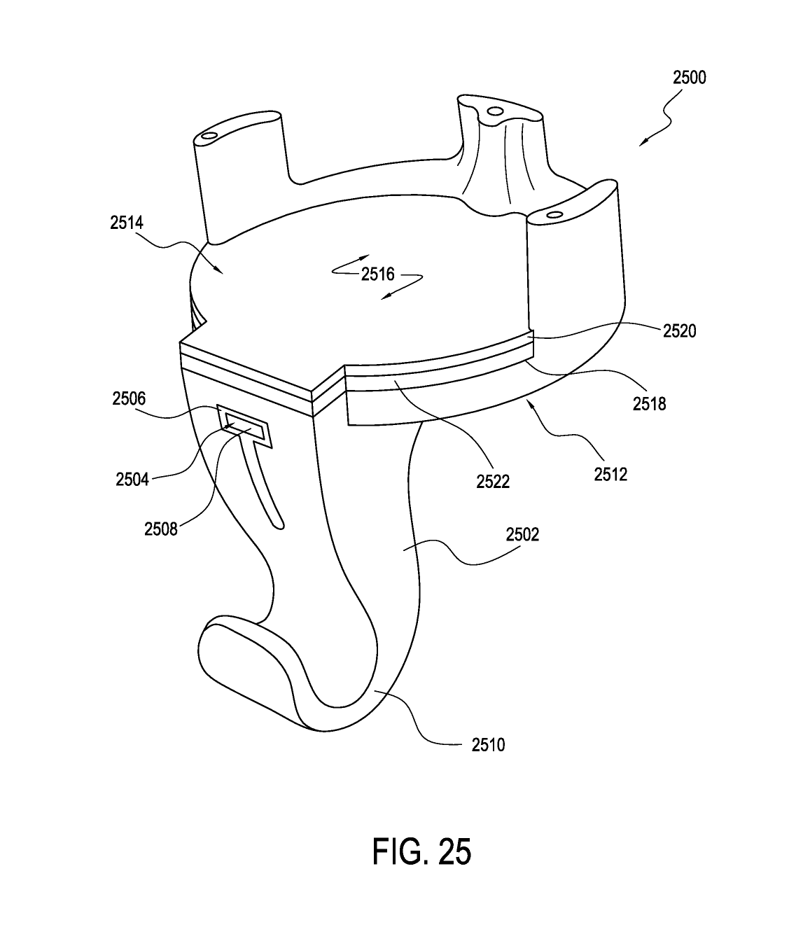

FIG. 25 shows a further embodiment of a localized outlet 2500 prepared according to principles of the invention. Similar to outlet 2200 (discussed above in relation to FIG. 22) outlet 2500 includes a generally vertical body portion 2502 having an aperture 2504 with a bezel 2506, a USB receptacle 2508, and an optional convenience feature such as a hook 2510, along with a horizontal body portion 2512. In addition, localized outlet 2500 includes an extended flange portion 2514. The extended flange portion 2514 has an upper surface region 2516 which, in certain embodiments, has a generally planar aspect and is disposed in a generally horizontal orientation when in use.

In certain embodiments and applications, upper surface region 2516 is arranged and configured to support a personal item such as, for example a personal electronic device (not shown). This configuration can be particularly convenient during charging of the personal electronic device as, for example, when the personal electronic device is coupled by a charging cable to the USB receptacle 2508.

In addition, as discussed above, in certain embodiments the extended flange portion 2514 includes a charging coil/antenna (not shown) for wireless charging of a device such as a personal electronic device. In such embodiments, a personal electronic device may be disposed adjacent to, or in spaced relation to, an upper surface region of the charging coil for wireless charging. In certain embodiments, the charging coil is operatively coupled by an electrical conductor to a power source (not shown) within a cavity in the body of the localized outlet 2500.

In certain embodiments of the invention, the extended flange portion 2514 includes a layer or member of transparent or translucent material 2518. By disposing a light source such as, for example, a light emitting diode internal to the localized outlet 2500, the transparent or translucent material can be illuminated so as to draw attention to the localized outlet 2500. This will be particularly effective in an environment that is otherwise relatively dark. In certain embodiments of the invention, a further layer or member of material 2520 is disposed above the layer or member 2518.

This further layer 2520 will, in certain embodiments, be less transparent or translucent than the underlying layer 2518 and will, in some embodiments, be substantially opaque. Consequently, a peripheral edge 2522 of material 2518 will be illuminated in strong contrast to the balance of the extended flange portion 2514. This peripheral edge illumination serves to further emphasize and draw attention to the localized outlet 2500 when in use.

In various embodiments of the invention, electronic devices within the localized outlet 2500 will be arranged and configured to allow this illumination to be of any desired color, to be of a color that changes on a random or patterned basis, or to assume a color corresponding to a state of the apparatus such as, for example, available, in use, charging, charge complete, etc. In addition, flashing light patterns and other effects will be available in corresponding embodiments of the invention.

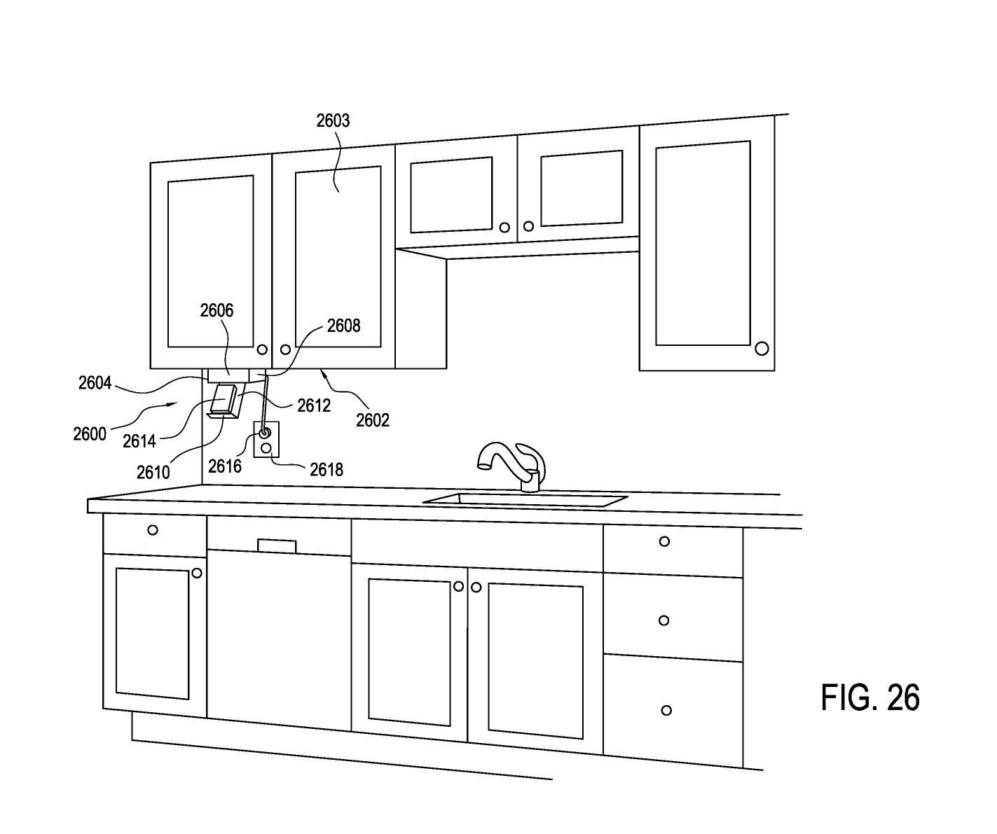

FIG. 26 shows, in schematic perspective view, certain features of a further embodiment of the invention including a localized outlet 2600. Localized outlet 2600 is configured for mounting to a generally downwardly facing generally horizontal surface such as an under-surface 2602 of the illustrated exemplary kitchen cabinet 2603.

The localized outlet 2600 includes a first supporting member (i.e., a body member) 2604 having a generally horizontal surface region having a first supporting surface 2606. According to one embodiment of the invention, first supporting surface 2606 is disposed in a generally horizontal orientation and is configured and arranged to receive and support a personal electronic device such as, for example, a smart phone or other cellular device.

The body member 2604 also includes a generally vertically oriented portion 2608 that is arranged and configured to be coupled to the under-surface 2602. Also coupled to the body member is a further member 2610. Further member 2610 includes a further supporting surface 2612. Further supporting surface 2612 is obliquely oriented with respect to the vertical, and is arranged and configured to support a personal electronic device such as, for example, a smart phone or other cellular device e.g., 2614.

In certain embodiments of the invention, the localized outlet 2600 will include an electronic device configured to provide electrical power to the personal electronic device 2614. In certain embodiments, the electronic device will receive electrical power at a first voltage and effect a voltage conversion function to provide electrical power to the personal electronic device 2614 at a second voltage. In at least one embodiment, the localized outlet 2600 will receive standard mains power through a power cord and standard mains plug 2616 from an ordinary wall receptacle 2618. In light of the further disclosure provided below, it will also be appreciated that, in certain embodiments, the localized outlet will be configured to receive power from an energy storage device such as, for example a rechargeable electrochemical battery.

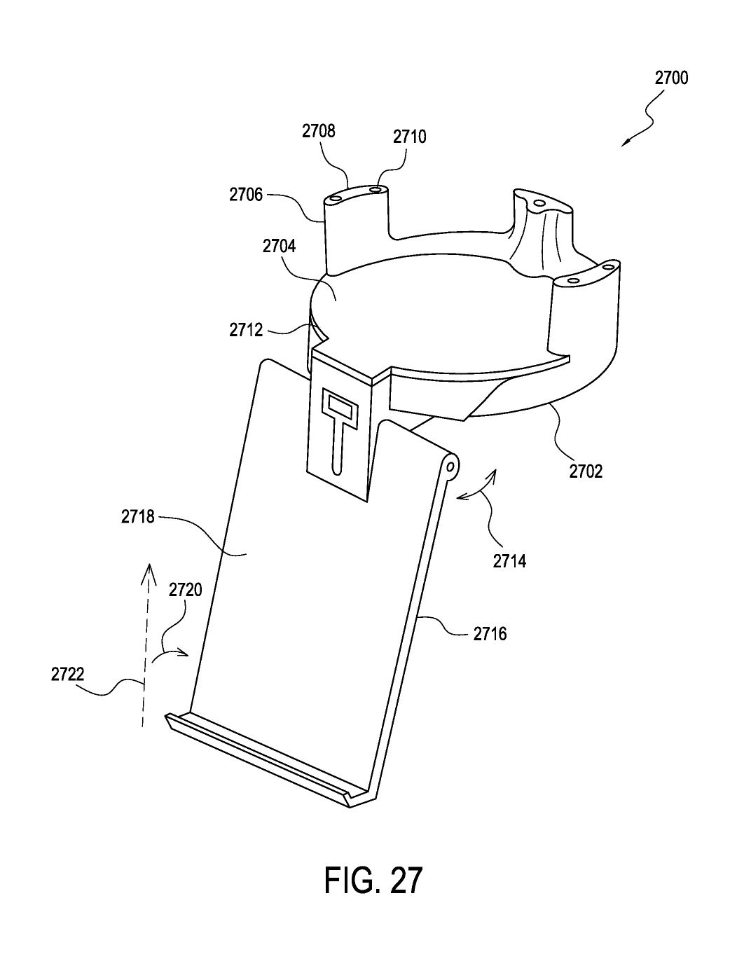

FIG. 27 shows, in schematic perspective view, certain features of a localized outlet 2700 exemplary of and configured to be mounted and employed as discussed above in relation to localized outlet 2600. Localized outlet 2700 includes a body member 2702 having an upper surface region 2704. The upper surface region is arranged and configured to support a personal electronic device.

In the illustrated embodiment, the body member 2702 includes at least one mounting column 2706. The mounting column 2706 is arranged and configured to allow for the coupling of body member 2702 to a generally horizontal downwardly facing surface as previously discussed. Thus, in the illustrated embodiment, first 2708 and second 2710 screw holes are visible in the mounting column 2706.

In certain embodiments, a peripheral surface region 2712 is transparent or translucent, and is arranged and configured to allow the passage of light therethrough so as to provide an illuminated accent to the body member 2702. In certain embodiments, the body member includes a Universal Serial Bus (USB) outlet port arranged and configured to provide power to a personal electronic device.

In the illustrated embodiment, the body member is pivotally coupled 2714 to a further support member 2716. The further support member 2716 includes a further support surface region 2718. In the illustrated embodiment, the further support member 2716 can be arranged in a first configuration whereby the further support region 2718 is disposed at a generally oblique angle 2720 to the vertical 2722.

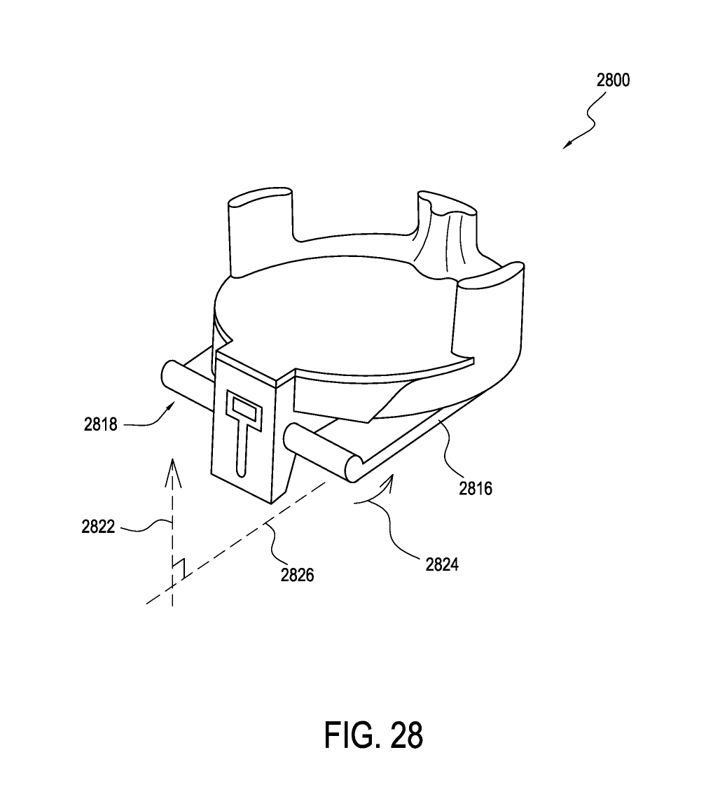

FIG. 28 shows the localized outlet 2800 in a second configuration in which the further support member 2816 has been rotated 2824 (or otherwise reconfigured) into a second configuration in which the further support surface region 2818 is disposed in a generally horizontal orientation 2826 (i.e., generally normal to the vertical 2822).

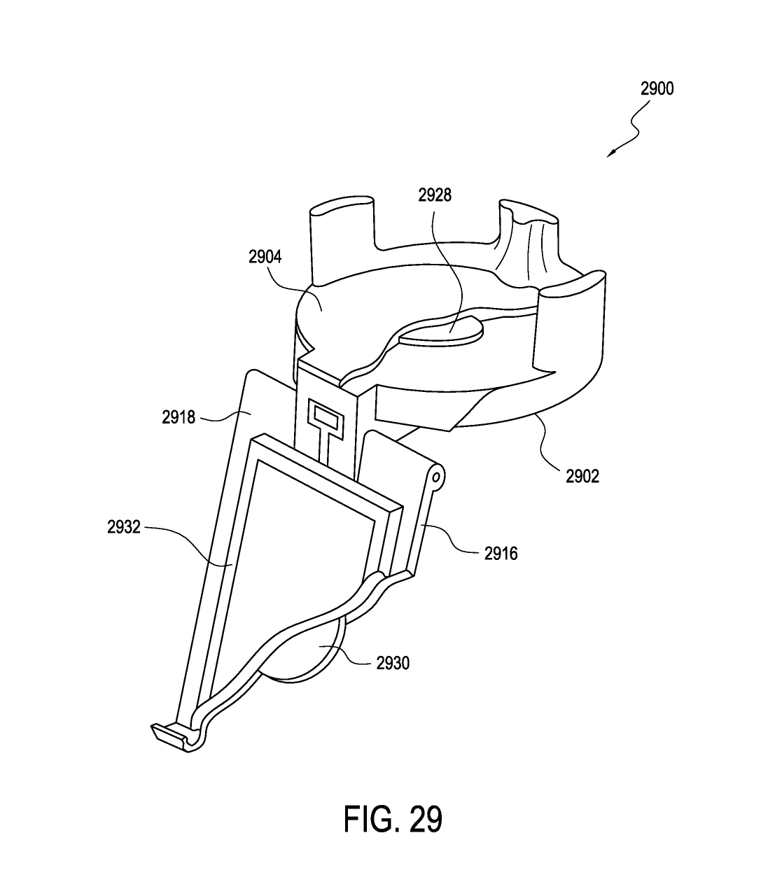

FIG. 29 shows, in schematic cutaway view, further aspects of the localized outlet 2900, including a first wireless charging coil 2928 disposed within the body member 2902 and in proximity to surface region 2904.

In the illustrated embodiment, the localized outlet 2900 includes a second wireless charging coil 2930 disposed within the further support member 2916 and in proximity to the further support surface region 2918. For purposes of illustration, the further support surface region 2918 is shown supporting an exemplary smart phone device 2932. The exemplary smart phone device 2932 is arranged and configured to be wirelessly charged by wireless charging coil 2930.

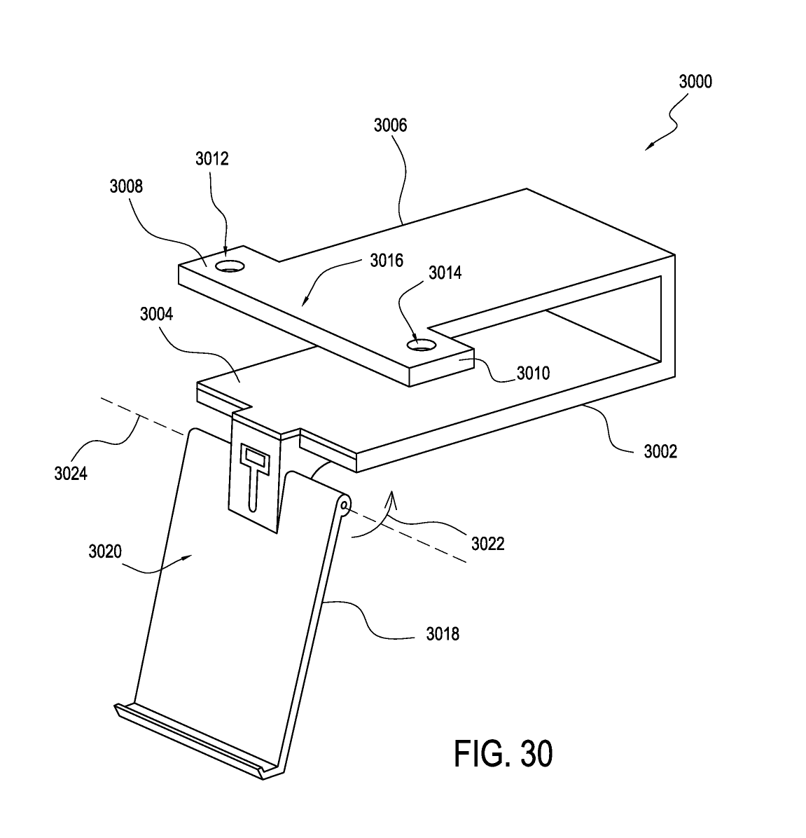

FIG. 30 shows, in schematic perspective view, a still further localized outlet 3000 prepared according to principles of the invention. Localized outlet 3000 includes a body member 3002 having a first support surface region 3004 arranged and configured to support a personal electronic device.

A mounting feature 3006 is provided to allow an installer to substantially fixedly couple the localized outlet 3002 to an overhead supporting element. In the illustrated embodiment, the mounting feature 3006 includes first 3008 and second 3010 mounting lug regions of the mounting feature 3006. The mounting lug regions 3008, 3010 include exemplary through holes 3012, 3014 for receiving respective wood screws or other fasteners (such as, e.g., metal screws, machine screws, self-tapping screws, rivets, nails etc.). It will be understood by one of skill in the art, however, that other fastening mechanisms will be appropriate to corresponding embodiments and applications of the invention. Thus, in certain embodiments, for example, a chemical adhesive material and/or a physical adhesive material will be deployed at surface region 3016 to couple surface region 3016 to a portion of the localized outlet's environment.

As shown, in certain embodiments, the localized outlet 3000 will also include a further supporting member 3018. The illustrated further supporting member 3018 includes a further supporting surface region 3020 arranged and configured to support, for example, a personal electronic device.

In the illustrated embodiment, the further supporting member 3018 is pivotally coupled 3022 to the body member 3002. In various embodiments, this pivotal coupling is achieved by a shaft or axle disposed between the further supporting member 3018 and the body member 3002 within respective bores and along a rotational axis 3024.

In still other embodiments, the further supporting member 3018 and the body member 3002 each includes at least one of a recess and a protrusion, where the recess of one is configured to receive the protrusion of the other so as to form a pivotal or hinged joint.

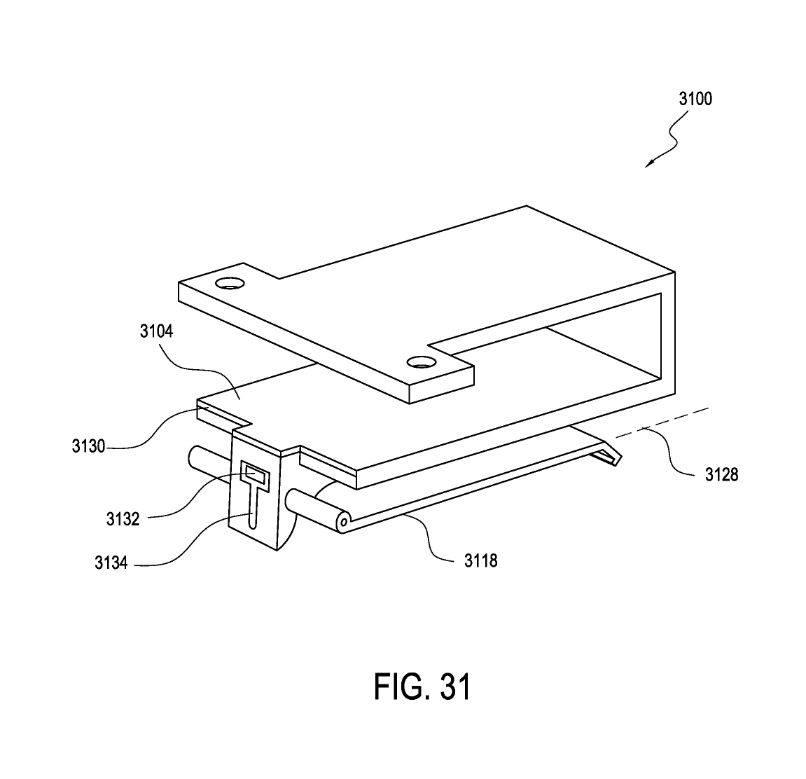

In certain embodiments of the invention, a detent mechanism will be provided to hold the further supporting member 3018 in a first orientation where the supporting surface region 3020 is oriented in a generally oblique angle to the vertical, and in a second orientation where the supporting surface region 3020 is maintained at a generally horizontal configuration 3128 as shown, for example, in FIG. 31.

Referring now to FIG. 31, in certain embodiments of the invention, the localized outlet 3100 will include an illuminated peripheral surface region 3130. In certain embodiments of the invention, the localized outlet 3100 will include a USB outlet 3132 as well as, in certain embodiments, an illuminated bezel 3134.

It will be noted that the supporting surface region 3104 of localized outlet 3100 has a generally rectangular aspect whereas the supporting surface region 2904 of localized outlet 2900 has a generally circular aspect. One of skill in the art will appreciate that these configurations are merely exemplary of a wide variety of arrangements and shapes intended to be within the scope of the present disclosure. Thus a supporting surface region of a localized outlet will have, in respective embodiments, any of a generally elliptical aspect, a generally polygonal aspect including any of triangular, square, rectangular, pentagonal, hexagonal, etc., amorphous, stellate, etc.

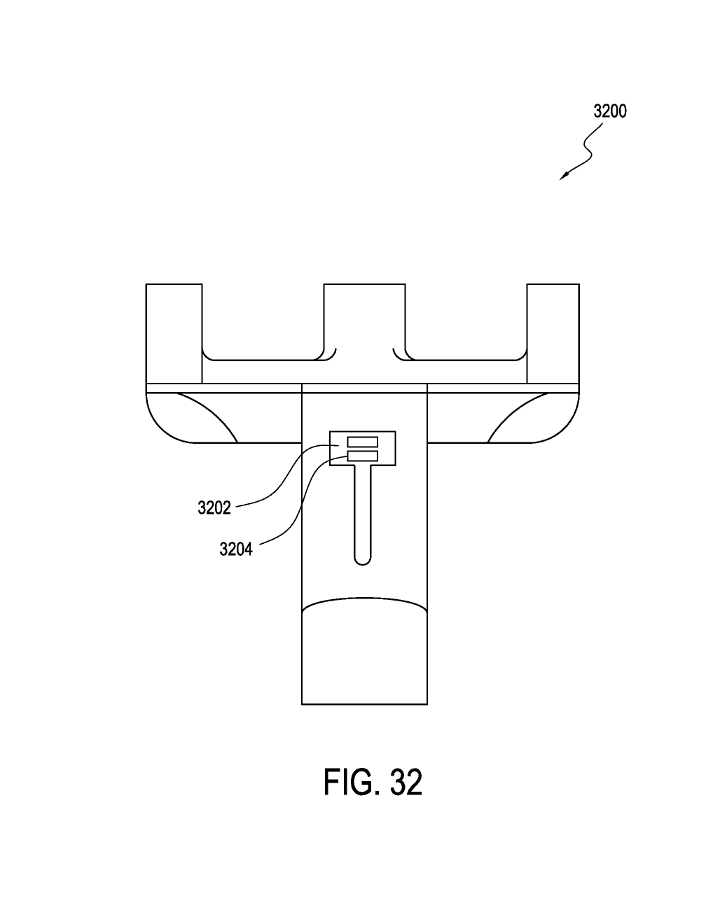

In certain embodiments of the invention, as illustrated, for example, in FIG. 32, a localized outlet 3200 will include a plurality of USB connectors e.g., 3202, 3204. In certain embodiments of the invention, USB connectors 3202 and 3204 will be type-C USB connectors.

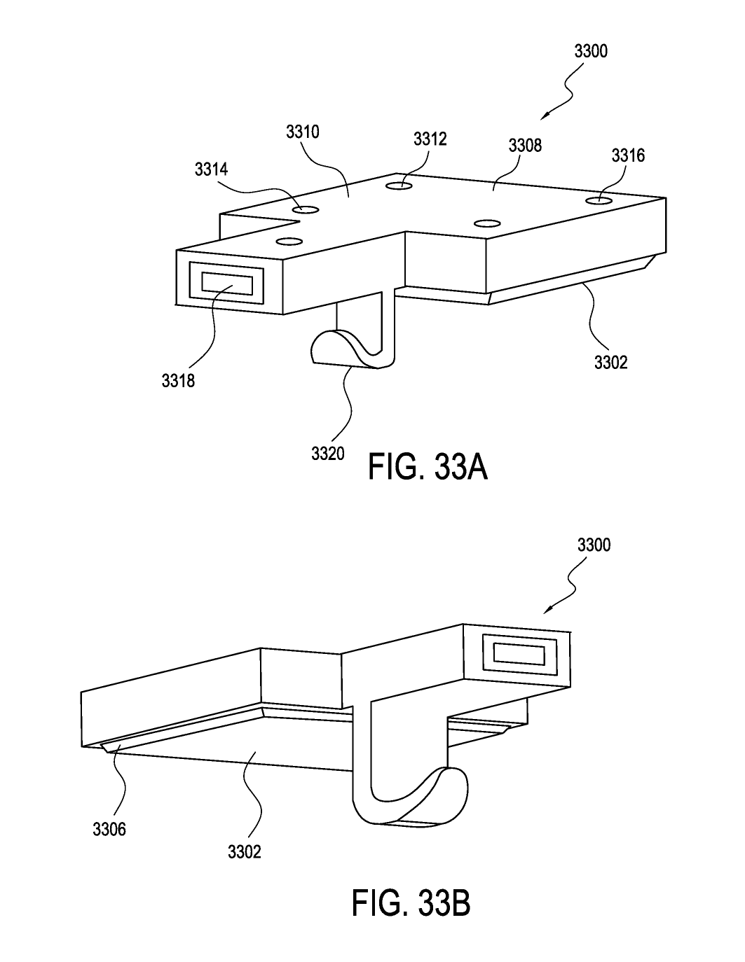

FIG. 33A shows, in perspective view, certain aspects of a localized outlet 3300 including an integrated energy storage device 3302. In the one embodiment, the energy storage device will include at least one electrochemical battery cell. In other embodiments of the invention, the energy storage device will include alternative energy storage apparatus including, for example, a capacitor (such as a super-capacitor) and electromechanical device such as, e.g. a flywheel and electromechanical generator, a fuel-cell and fuel storage reservoir, a heat engine and fuel storage reservoir or any other energy storage apparatus, appropriate to the circumstances, that is or becomes available.

Referring now to FIG. 33B, in one embodiment of the invention, as illustrated, the battery 3302 of the localized outlet 3300 includes a removable battery pack. The removable battery pack fits within a receptacle area 3306 of the localized outlet 3300 and is held in place by a detent mechanism (not shown). When it is determined that the battery 3302 has more or less discharged, it is removed from the receptacle area 3306 by releasing the detent mechanism and either recharged and replaced or exchanged with a further battery pack having sufficient stored energy.

Accordingly, in certain circumstances it will be beneficial to provide a charging module that includes an energy storage device such as, for example, an electrochemical battery. In certain embodiments of the invention, as discussed and above a localized outlet 3300 includes an electrical power supply that receives mains power and produces an intermediate voltage. The intermediate voltage produced by the power supply is connected through fixed wiring to the localized outlet.

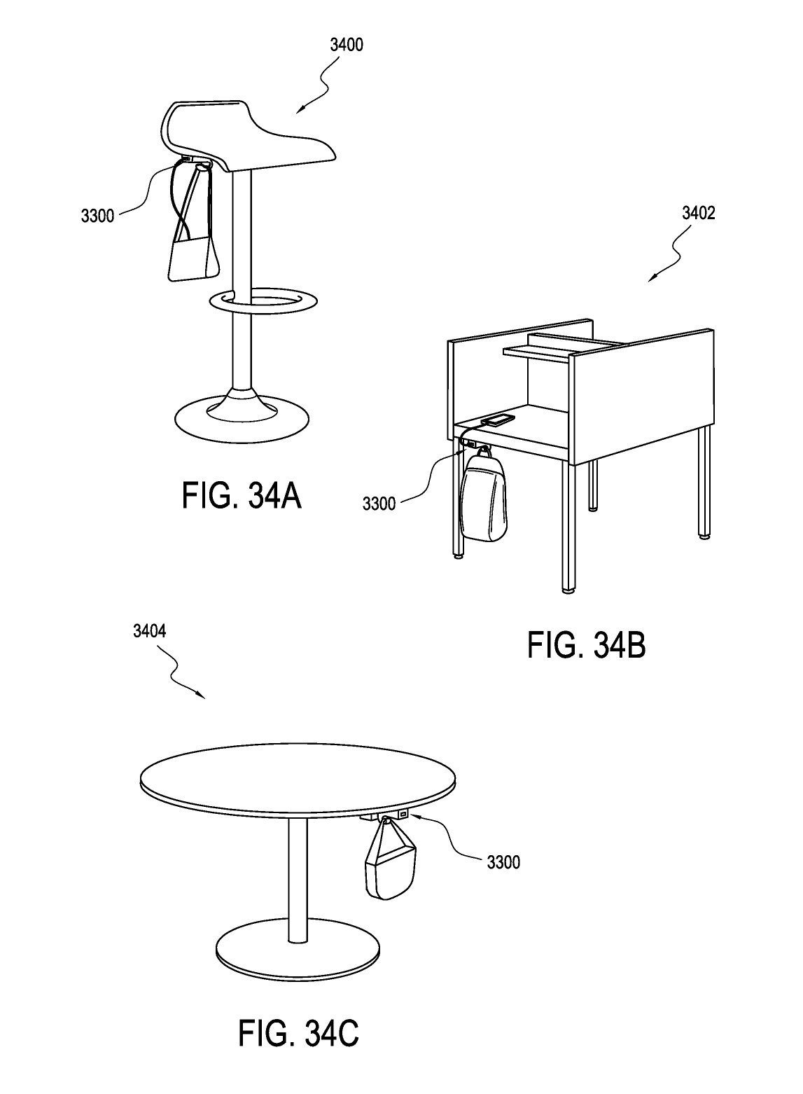

Connection to mains power is often not convenient, however. In particular, it will also be impractical to power such a system with mains power where it is desirable to couple the localized outlet 3300 to a movable piece of furniture such as, for example a bar stool 3400 (FIG. 34A), a study carrel 3402 (FIG. 34B) or a movable table 3404 (FIG. 34C). In such circumstances, a localized outlet 3300 powered by a rechargeable or replaceable battery (or other energy storage device) offers substantial advantages over alternative technologies, to the extent that such technologies exist at all.

Referring again to FIGS. 33A and 33B, one sees that the localized outlet 3300 includes a housing 3308 with a receptacle area 3306. An upper surface region 3310 of housing 3308 includes one or mounting holes e.g., 3312, 3314, 3316. As discussed above, such mounting holes can be used to couple the housing 3308 to an undersurface of, for example, a table, a chair, a desk or any other desirable location.

Similar to many of the embodiments discussed above, the illustrated exemplary localized outlet 3300 includes a USB receptacle 3318 and a convenience feature 3320 (here a hook).

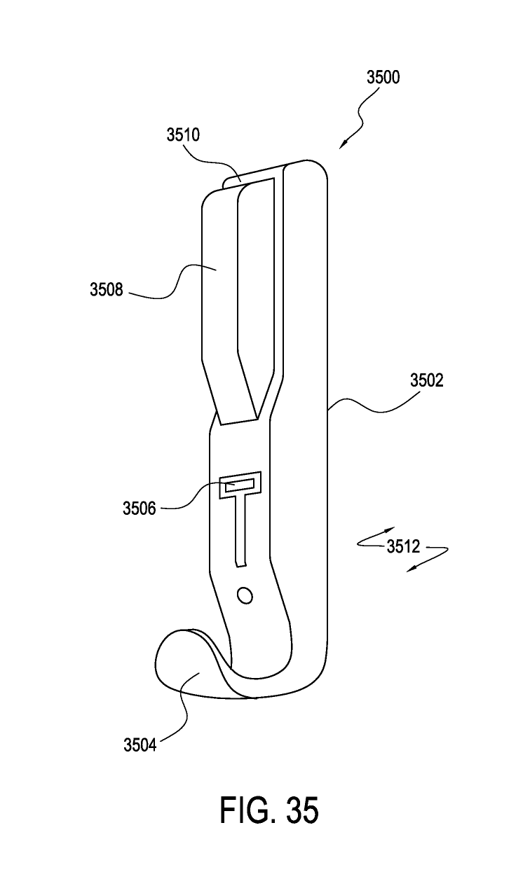

FIG. 35 shows, in perspective view, an alternative localized outlet 3500 prepared according to principles of the invention. Localized outlet 3500 includes a housing portion 3502 with a convenience feature 3504 and a USB outlet 3506. A battery module 3508 is shown disposed within a receptacle region 3510 of the housing 3502.

Consistent with the various descriptions provided above, the housing 3502 is arranged and configured to be installed by mounting to a generally vertical surface 3512 of a wall, a furnishing element (such as desk, chair, a table, a nightstand, a bookcase, etc.), or any other location where the availability of a combined convenience feature and charging station would be beneficial. For example, installation in a mud room, a foyer, a stairway, or a closet would offer a user such as a homeowner great benefit with a minimum of installation cost and effort. In addition, a versatile apparatus like that described, can be mounted indoors, outdoors and within a vehicle or, for example a sports facility locker, a work facility locker or a transportation station locker.

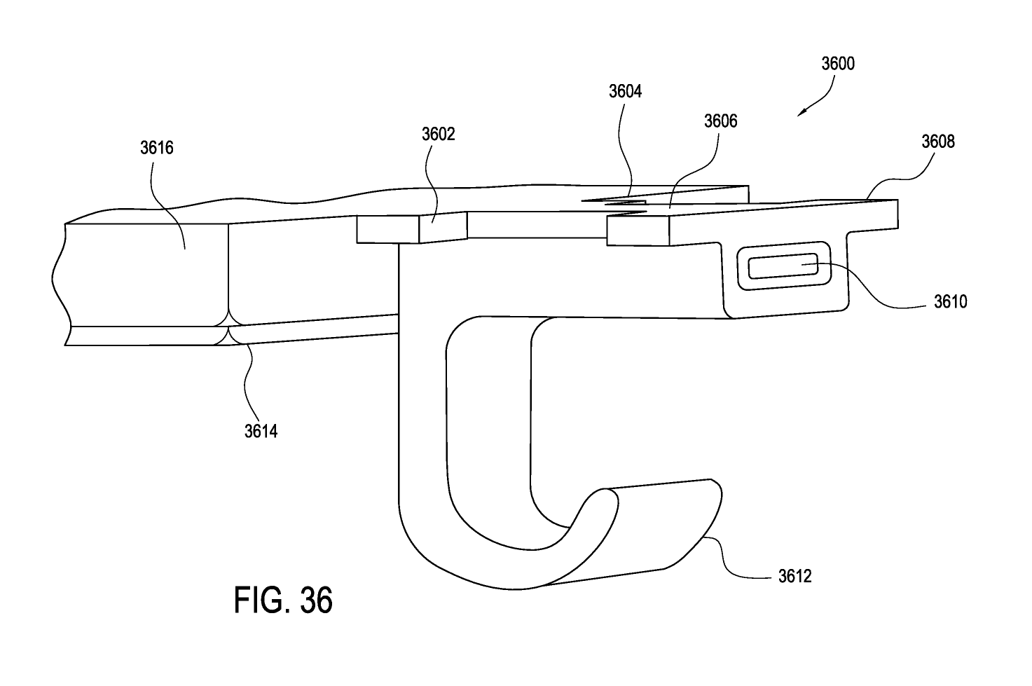

In this context, FIG. 36 shows, in perspective view, a portion of a localized outlet 3600 including a plurality of mounting lugs 3602, 3604, 3606 and 3608, a USB port 3610, a handbag hook 3612 and a battery 3614 in a battery receptacle 3616.

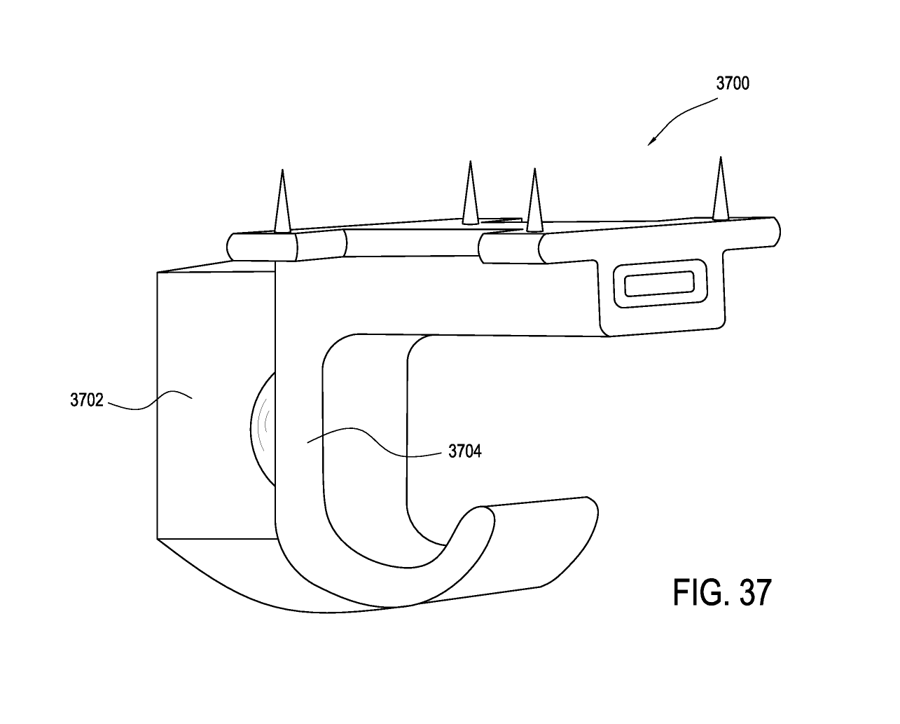

FIG. 37 shows a further arrangement in which a localized outlet 3700 includes a battery 3702 removably or rechargeably coupled to a distal surface of a housing 3704.

In various embodiments of the invention, a localized outlet having a battery power supply will include an annunciator device for indicating to a user that the supply battery is running low and/or in need of recharging. Such an annunciator device may include an audible annunciator, a visual indicator such as, for example a steady or flashing light. In addition, certain localized outlets prepared according to principles of the invention will include one or more of a communication facility such as Bluetooth, Wi-Fi, infrared signaling, ultrasonic signaling cell phone communication or other communication means for contacting a remote monitoring device such as, for example, a cell phone of a user, to indicate its depleted charge state (or any other relevant status).

In certain embodiments of the invention, the battery powered localized outlet will include a chronometer device. The chronometer device will coordinate with control features of the localized outlet to ensure that low battery annunciation, or other communications, will take place only during a desirable time. Accordingly, for example, in a restaurant environment, an audible annunciator will be activated only during a time interval when restaurant clients are not present. Likewise, in a domestically-installed localized outlet, annunciation will be suppressed during sleeping hours.

In certain embodiments, the timing of such annunciation will be programmable by a user. Accordingly, in certain embodiments of the invention, the battery powered localized outlet will include a computer processor device configured to effect such desirable features.

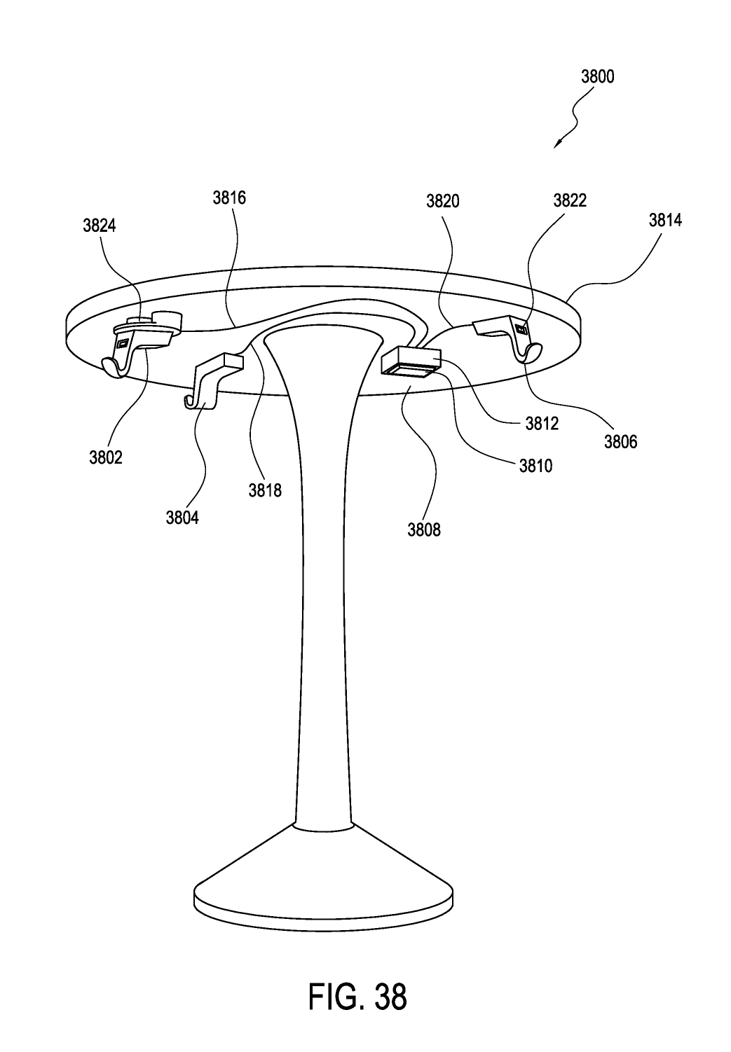

Referring now to FIG. 38, according to certain embodiments, the invention includes a charging system 3800. The charging system includes a plurality of localized charging outlets, e.g., 3802, 3804, 3806, for a charging system that are mutually operatively coupled to a common battery pack 3808. The battery pack 3808 includes a battery portion 3810 and a receptacle portion 3812.

As illustrated, the localized outlets 3802, 3804, 3806 and the battery pack receptacle 3812 are fastened to respective lower surface regions of, for example, a table 3814. As will be appreciated by one of skill in the art, this fastening will be achieved in respective embodiments by any of wood screws, machine screws, chemical adhesives (including, without limitation, cyanoacrylate adhesives, epoxies, acetone solvent adhesives), thermal adhesives including, for example and without limitation, hot glue, any form of welding (including, without limitation, electric arc welding, make welding, take welding, laser welding, ultrasonic welding), and any other fastening method appropriate to the particular circumstances that are known or may become known in the art.

In certain embodiments, each localized outlet 3802, 3804, 3806 includes a respective pigtail cable 3816, 3818, 3820 having, therewithin, at least first and second electrical conductors. The pigtail cables, and their respective electrical conductors are coupled to the battery pack receptacle 3812 and, through the battery pack receptacle 3812 to a battery portion 3810 disposed within the battery pack receptacle 3812.

Accordingly, the battery portion 3810 supplies electrical energy through the respective pigtail cables to the respective localized charging outlets. Consequently, and as described elsewhere in this application, the electrical energy of the battery portion becomes available for charging, e.g., a personal electronic device that is coupled through a charging cable to a USB outlet, e.g. 3822. Similarly, a personal electronic device disposed within a charging area, e.g., 3824 of a wireless charging localized outlet will be charged with energy received from the battery portion 3810.

According to certain aspects and embodiments, the invention will include a method of replacing the battery portion 3810 either periodically or according to an indication from a charge level indicator (such as, for example, an audible indicator). In certain embodiments, the battery pack 3808, will include a controller. The controller will include, in certain embodiments, a charge status sensor (including, for example, a voltage sensor and/or a current sensor) and a communication device. In certain embodiments, the communication device will include a cellular telephone communication device. In certain embodiments, the invention includes an indication device that is adapted and configured to communicate with a personal electronic device of a user. This communication will, in exemplary embodiments, indicate charge level and/or request replacement of a battery portion e.g., 3810.

In certain embodiments of the invention, the method will include rolling a mobile charging station from location to location within an establishment and exchanging charged battery portions for more or less uncharged battery portions at respective locations.

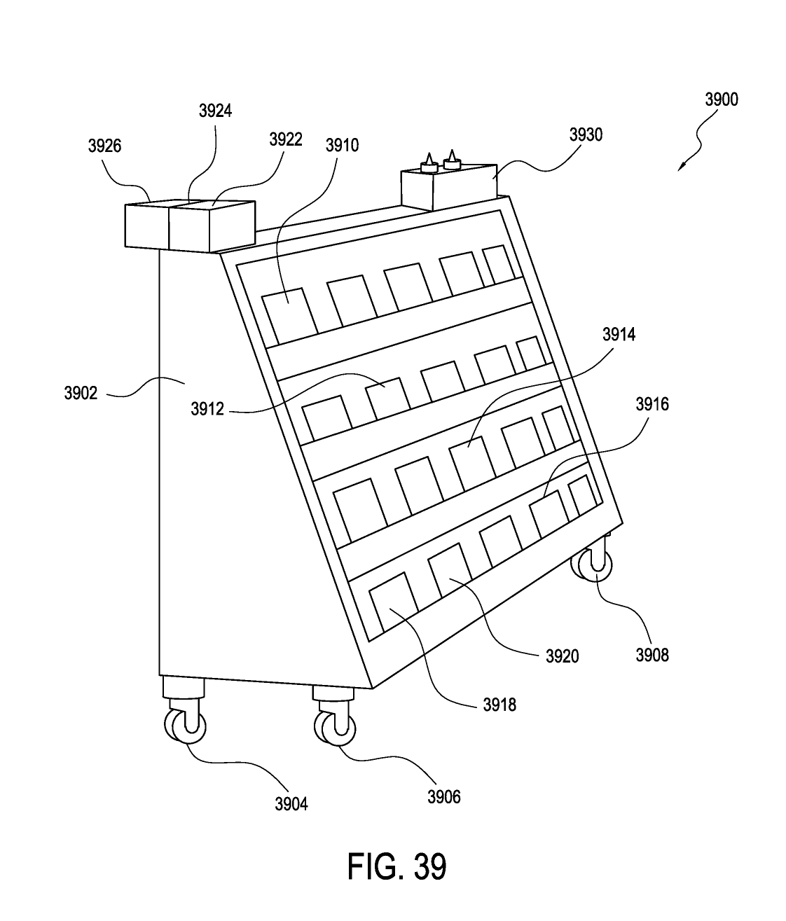

FIG. 39 shows an exemplary mobile charging station 3900 according to certain embodiments of the invention. The charging station includes, for example, housing 3902 including a plurality of wheels, e.g. 3904, 3906, 3908 or other friction reducing/mobility enhancing devices. The charging station also includes a plurality of receptacles e.g., 3910, 3912, 3914, 3916, 3918, 3920, each adapted to receive a respective battery portion like that, 3910, described above. In addition, the mobile charging station 3900 includes a charging apparatus 3922 (i.e., battery charger) arranged and configured to produce an appropriate charging voltage and current for charging the various respective battery portions. The battery charger will include electronic devices configured according to a particular application as will be readily understood by one of skill in the art.

In certain embodiments, the mobile charging station will include a plug and receptacle combination 3924, or other appropriate power coupling device, arranged and configured for ready coupling of the charging apparatus to a source of mains power 3926. In other embodiments, a wireless power coupling will be included for ready coupling of the charging apparatus to a source of mains power. In certain further embodiments, the mobile charging station will include a condiment service tray 3930 so that, for example, restaurant staff can replace a battery and service table condiments as part of a common activity cycle.

One of skill in the art will appreciate that, in certain embodiments, the entire mobile charging station will include a computer processor and other robotic features arranged to allow automatic replenishment of battery portions where appropriate.

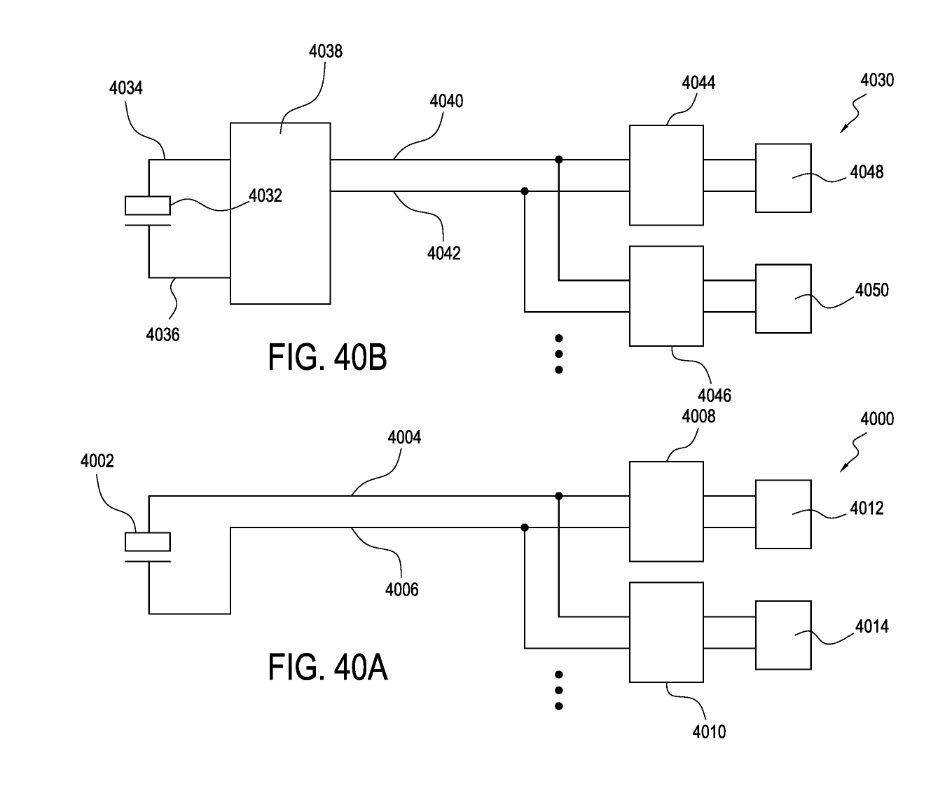

FIG. 40A shows, in schematic block diagram form, a circuit for a portion of a charging system 4000 prepared according to principles of the invention. In the illustrated embodiment, the charging system 4000 includes a system supply battery 4002. The system supply battery 4002 is operatively coupled through supply battery voltage wiring 4004, 4006 to respective power input ports of at least one localized power outlet, e.g. 4008, 4010. The localized power outlet, e.g. 4008, 4010 converts a supply battery voltage present on the supply battery voltage wiring 4004, 4006 to a low voltage, such as a five volt output voltage of a respective USB receptacle, e.g., 4012, 4014.

In contrast, FIG. 40B shows, in schematic block diagram form, a circuit for a portion of a charging system 4030, also prepared according to principles of the invention. In the illustrated embodiment, the charging system 4030 includes a system supply battery 4032. The system supply battery 4032 is operatively coupled through first supply battery voltage wiring 4034, 4036 to a power input port of a first voltage converter 4038. An output port of the first voltage converter 4038 is operatively coupled through intermediate voltage wiring 4040, 4042 to respective power input ports of at least one localized power outlet, e.g. 4044, 4046. The localized power outlet, e.g. 4044, 4046 converts an intermediate voltage present on the intermediate voltage wiring 4044, 4046 to a low voltage, such as a five volt output voltage of a respective USB receptacle, e.g., 4048, 4050.

One of skill in the art will appreciate that, given the current state of electrochemical battery technology, it is generally more efficient to store energy at a relatively high voltage rather than at a relatively low voltage. Accordingly, in certain circumstances, employing a higher voltage supply battery and an intermediate power converter will result in an overall improvement in system characteristics. In light of the foregoing disclosure, it will be understood that one could also provide a power supply battery having an output voltage substantially equal to the desired ultimate output voltage (e.g., USB output voltage). In contrast to the illustrated systems, such a system would require heavier gauge wiring and would be subject to loading effects as multiple devices were charged. Nevertheless, in certain embodiments of the invention, a system of this nature will be employed.

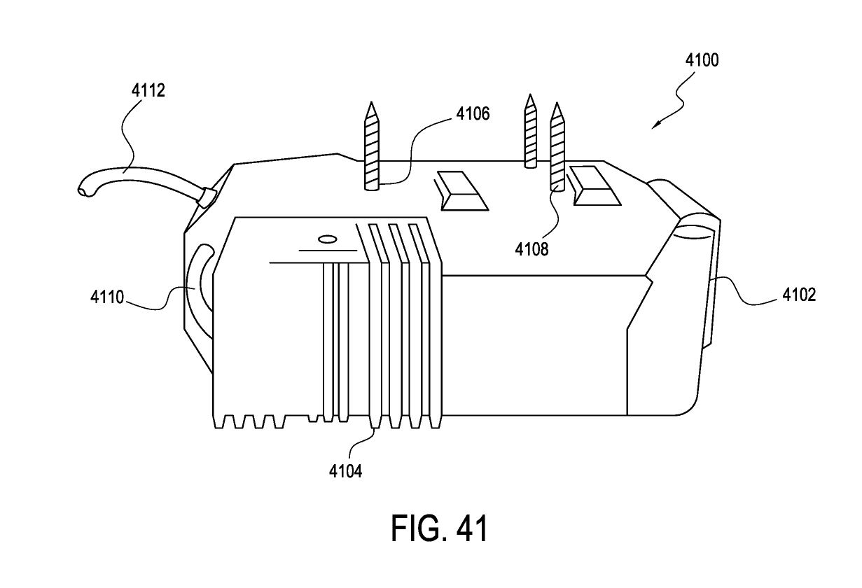

FIG. 41 shows a power supply battery receptacle 4100 including a battery 4102 and a power converter 4104 for producing an intermediate voltage like converter 4038 discussed with respect to system 4030. The illustrated receptacle includes apertures, e.g. 4106, 4108 for mounting screws. Wiring, 4110 supplies battery voltage to the power converter 4104 and returns intermediate voltage power which then emerges on intermediate voltage output wiring 4112.

In light of the foregoing, it will be apparent to one of skill in the art that a charging system including a supply battery like battery 4002 four 4032 will be readily employed with any of the many localized outputs described above, alone or in combination.

In certain embodiments of the invention, the convenience feature will include a security feature. Thus, for example, in certain embodiments of the invention, where the convenience feature is a hook, the hook will include a clasp or latch that will be locked mechanically or electronically by a user. This will tend to reduce the risk that a personal article suspended from the hook will be absconded with.

Likewise, in certain embodiments of the invention, an electronic alarm feature will be provided that notifies a user when a personal electronic device being charged at a localized outlet is disconnected from that outlet without the entry of a password or other (e.g., biometric) securing input. In certain embodiments, this functionality will be provided by hardware and/or software within the charging system or by an app or other software within the personal electronic device being charged or by a combination of both.

One of skill in the art will appreciate that the USB receptacle presented in relation to various localized outlets for purposes of the present disclosure is merely exemplary of a wide variety of functional couplings that will be employed in respective embodiments of the invention. Thus, for example, any appropriate wired and/or wireless charging mechanism (presently known or that becomes known to one of skill in the art) is intended to fall within the scope of the present disclosure.

Accordingly, in respective embodiments, a localized outlet will include one or more of a USB outlet, a miniature USB outlet, an inductive or other electromagnetic wireless charging system, an optical or other wireless charging system, or any other system compatible with personal devices and other portable equipment in the future.

While the exemplary embodiments described above have been chosen primarily from the field of convenience chargers and charging systems for commercial establishments, one of skill in the art will appreciate that the principles of the invention are equally well applied, and that the benefits of the present invention are equally well realized, in a wide variety of other circumstances and environments including, for example, those found in home, automotive and public spaces. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but should occupy the full scope of the appended claims, and such other claims as may be properly presented in the future.

1. A charging system comprising:
a mobile charging station including a plurality of battery charging receptacles;
a plurality of primary batteries adapted to be charged within said charging receptacles;
a plurality of primary battery receptacles physically coupled to respective mounting locations; and
a plurality of pigtail cables operatively coupled from said plurality of battery receptacles to respective individual charging stations, said individual charging stations being mounted at respective service locations generally proximate to said mounting locations and adapted to charge individual personal electronic devices at respective output ports thereof.

2. A charging system as defined in claim 1, wherein at least one of said mounting locations is a domestic kitchen island.

3. A charging system as defined in claim 1, wherein at least one of said mounting locations is a restaurant table.

4. A charging system as defined in claim 1, wherein at least one of said mounting locations is a library study carrel.

5. A charging system as defined in claim 1, wherein at least one of said mounting locations is a sports facility locker.

6. A charging system as defined in claim 1, wherein at least one of said mounting locations is a student classroom desk.

7. A charging system as defined in claim 1 wherein said mobile charging station further includes a condiment service tray.

8. A charging system as defined in claim 1 wherein said mobile charging station will include a coupling device for receiving mains power.

9. A charging system as defined in claim 1 wherein at least one of said individual charging stations includes a wireless coupling device for wireless charging of a personal electronic device.

10. A method of charging a personal digital assistant device as defined in claim 9 wherein said wireless coupling device comprises a near field electromagnetic induction coupling device.
